(19) United States
(12) Patent Application Publication
(10) Pub. No.: US 2021/0191394 A1
(43) Pub. Date: Jun. 24, 2021

(54) SYSTEMS AND METHODS FOR PRESENTING CURATED AUTONOMY-SYSTEM INFORMATION OF A VEHICLE

(71) Applicant: Lyft, Inc., San Francisco, CA (US)

(72) Inventors: Eric Richard Dudley, Grand Island, NY (US); Vicky Cheng Tang, San Jose, CA (US); Sterling Gordon Halbert, Redwood City, CA (US)

(21) Appl. No.: 16/719,704

(22) Filed: Dec. 18, 2019

(51) Int. Cl. G05D 1/00; G05D 1/02; B60W 40/02

(52) U.S. Cl. CPC G05D 1/0061; B60W 2050/146; B60W 40/02; G05D 1/021

(57) ABSTRACT

Examples disclosed herein may involve (i) obtaining data that characterizes a current scenario being faced by a vehicle that is operating in an autonomous mode while in a real-world environment, (ii) based on the obtained data that characterizes the current scenario being faced by the vehicle, determining that the current scenario being faced by the vehicle warrants presentation of scenario-based information to a user (e.g., an individual tasked with overseeing operation of the vehicle), and (iii) in response to the determining, presenting a given set of scenario-based information to the user via one or both of a heads-up-display (HUD) system or a speaker system of the vehicle.

### BACKGROUND

Vehicles are increasingly being equipped with technology that enables them to operate in an autonomous mode in which the vehicles are capable of sensing aspects of their surrounding environment and performing certain driving-related tasks with little or no human input, as appropriate. For instance, vehicles may be equipped with sensors that are configured to capture data representing the vehicle's surrounding environment, an on-board computing system that is configured to perform various functions that facilitate autonomous operation, including but not limited to localization, object detection, and behavior planning, and actuators that are configured to control the physical behavior of the vehicle, among other possibilities.

### SUMMARY

In one aspect, the disclosed technology may take the form of a method that involves (i) obtaining data that characterizes a current scenario being faced by a vehicle that is operating in an autonomous mode while in a real-world environment, (ii) based on the obtained data that characterizes the current scenario being faced by the vehicle, determining that the current scenario being faced by the vehicle warrants presentation of scenario-based information to a user (e.g., an individual tasked with overseeing operation of the vehicle), and (iii) in response to the determining, presenting a given set of scenario-based information to the user via one or both of a heads-up-display (HUD) system or a speaker system of the vehicle.

In example embodiments, the obtained that characterizes the current scenario being faced by the vehicle comprise one or more of (i) an indicator of at least one given scenario type that is currently being faced by the vehicle, (ii) a value that reflects a likelihood of the vehicle making physical contact with another object in the real-world environment during a future window of time, (iii) a value that reflects an urgency level of the current scenario being faced by the vehicle, or (iv) a value that reflects a likelihood that a safety driver of the vehicle will decide to switch the vehicle from the autonomous mode to a manual mode during the future window of time.

In example embodiments where the obtained data comprises an indicator of at least one given scenario type that is currently being faced by the vehicle, the function of determining that the current scenario being faced by the vehicle warrants presentation of scenario-based information may involve determining that the given scenario type matches one of a plurality of predefined scenario types that have been categorized as presenting increased risk.

Further, in example embodiments where the obtained data comprises a value that reflects a likelihood of the vehicle making physical contact with another object in the real-world environment during a future window of time, the function of determining that the current scenario being faced by the vehicle warrants presentation of scenario-based information may involve determining that the obtained value for the likelihood-of-contact data variable satisfies a threshold condition associated with the likelihood of the vehicle making physical contact with another object.

Further yet, in example embodiments where the obtained data comprises a value that reflects an urgency level of the current scenario being faced by the vehicle, the function of determining that the current scenario being faced by the vehicle warrants presentation of scenario-based information may involve determining that the obtained value for the urgency data variable satisfies a threshold condition associated with the urgency level.

Further still, in example embodiments where the obtained data comprises a value that reflects a likelihood that a safety driver of the vehicle will decide to switch the vehicle from the autonomous mode to a manual mode during a future window of time, the function of determining that the current scenario being faced by the vehicle warrants presentation of scenario-based information may involve determining that the obtained value for the likelihood-of-disengagement data variable satisfies a threshold condition associated with the likelihood that the safety driver of the vehicle will decide to switch the vehicle from the autonomous mode to the manual mode.

In example embodiments, the given set of scenario-based information may be selected based on the obtained data that characterizes the current scenario being faced by the vehicle.

Additionally, in example embodiments, the given set of scenario-based information may comprise a bounding box and a predicted future trajectory for at least one other object detected in the real-world environment, and the function of presenting the given set of scenario-based information may involve presenting a visual indication of the bounding box and the predicted future trajectory for the at least one other object via the HUD system of the vehicle.

Additionally still, in example embodiments, the given set of scenario-based information may comprise a stop fence for the vehicle, and the function of presenting the given set of scenario-based information may involve presenting a visual indication of the stop fence via the HUD system of the vehicle.

In example embodiments, the method may also additionally involve, prior to determining that the current scenario being faced by the vehicle warrants presentation of scenario-based information, presenting baseline information via one or both of the HUD system or the speaker system of the vehicle while the vehicle is operating in the autonomous mode, where the baseline information is presented regardless of the current scenario being faced by the vehicle. Such baseline information may comprise a planned trajectory of the vehicle, among other examples.

In another aspect, the disclosed technology may take the form of a non-transitory computer-readable medium comprising program instructions stored thereon that are executable by at least one processor such that a computing system is capable of carrying out the functions of the aforementioned method.

In yet another aspect, the disclosed technology may take the form of an on-board computing system of a vehicle comprising at least one processor, a non-transitory computer-readable medium, and program instructions stored on the non-transitory computer-readable medium that are executable by the at least one processor such that the on-board computing system is capable of carrying out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1A is a diagram that illustrates a front interior of an example vehicle that is set up for both a safety driver and a safety engineer.

FIG. 1B is a diagram that illustrates one possible example of a visualization that may be presented to a safety engineer of the example vehicle of FIG. 1A while that vehicle is operating in an autonomous mode.

FIG. 2A is a diagram that illustrates a view out of a windshield of an example vehicle at a first time while that vehicle is operating in an autonomous mode in a real-world environment.

FIG. 2B is a diagram that illustrates a view out of the windshield of the example vehicle of FIG. 2A at a second time while that vehicle is operating in an autonomous mode in the real-world environment.

FIG. 2C is a diagram that shows a bird's eye view of a scenario faced by the example vehicle of FIG. 2A at a third time while that vehicle is operating in an autonomous mode in the real-world environment.

FIG. 2D is a diagram that illustrates a view out of the windshield of the example vehicle of FIG. 2A at the third time while that vehicle is operating in an autonomous mode in the real-world environment.

FIG. 3A is a simplified block diagram showing example systems that may be included in an example vehicle.

FIG. 3B is a simplified block diagram of example systems that may be included in an example vehicle that is configured in accordance with the present disclosure.

FIG. 4 is a functional block diagram that illustrates one example embodiment of the disclosed technology for presenting a safety driver of a vehicle with a curated set of information related to a current scenario being faced by the vehicle.

FIG. 5 is a simplified block diagram that illustrates one example of a ride-services platform.

### DETAILED DESCRIPTION

As discussed above, vehicles are increasingly being equipped with technology that enables them to operate in an autonomous mode in which the vehicles are capable of sensing aspects of their surrounding environment and performing certain driving-related tasks with little or no human input, as appropriate. At times, these vehicles may be referred to as “autonomous vehicles” or “AVs” (which generally covers any type of vehicle having autonomous technology, including but not limited to fully-autonomous vehicles and semi-autonomous vehicles having any of various different levels of autonomous technology), and the autonomous technology that enables an AV to operate in an autonomous mode may be referred to herein as the AV's “autonomy system.”

While an AV is operating in an autonomous mode, one or more humans may also be tasked with overseeing the operation of the AV within its surrounding environment. For instance, one type of human that has responsibility for overseeing an AV's operation within its surrounding environment may take the form of a “safety driver,” which is a human that is tasked with monitoring the AV's behavior and real-world surroundings while the AV is operating in an autonomous mode, and if certain circumstances arise, then switching the AV from autonomous mode to a manual mode in which the human safety driver assumes control of the AV (which may also be referred to as “disengaging” the AV's autonomy system). For example, if a safety driver of an AV operating in autonomous mode observes that the AV's driving behavior presents a potential safety concern or is otherwise not in compliance with an operational design domain (ODD) for the AV, the safety driver may decide to switch the AV from autonomous mode to manual mode and begin manually driving the AV. In practice, such a safety driver could either be a “local” safety driver who is physically located within the AV or a “remote” safety driver (or sometimes called a “teleoperator”) who is located remotely from the AV but still has the capability to monitor the AV's operation within its surrounding environment and potentially assume control the AV via a communication network or the like.

When a safety driver has been tasked with overseeing an AV's operation within its surrounding environment, it is generally desirable for that safety driver to make timely and accurate decisions regarding whether to switch the AV from autonomous mode to manual mode. Indeed, if the safety driver waits too long before switching the AV from autonomous mode to manual mode and taking over control of the AV, this could lead to undesirable driving behavior and potentially increase the risk of a safety incident such as a collision. On the other hand, if the safety driver prematurely switches the AV from autonomous mode to manual mode in a scenario where disengaging the AV's autonomy system was unnecessary, this impedes the ability of the AV's autonomy system to operate as intended and mitigates the value of equipping AVs with autonomous technology in the first place. Thus, there is currently a need for technology that can help a safety driver decide whether (and when) to switch an AV from autonomous mode to manual mode.

One potential way to fill this need is by leveraging the rich set of data used by the AV's autonomy system to engage in autonomous operation, which may include sensor data captured by the AV, map data related to the AV's surrounding environment, data indicating objects that have been detected by the AV in its surrounding environment, data indicating the predicted future behavior of the detected objects, data indicating the planned behavior of the AV (e.g., the planned trajectory of the AV), data indicating a current state of the AV, and data indicating the operating health of certain systems and/or components of the AV, among other possibilities. Indeed, such data may provide insight as to the future behavior of both the AV itself and the other objects in the AV's surrounding environment, which may help inform a safety driver's decision as to whether (and when) to switch an AV from autonomous mode to manual mode.

In this respect, it is now common for a safety driver of an AV to be paired with a “safety engineer” (or at times referred to as a “co-pilot”), which is another human that is tasked with monitoring a visualization of information about the operation of the AV's autonomy system, identifying certain information that the safety engineer considers to be most relevant to the safety driver's decision as to whether to switch the AV from autonomous mode to manual mode, and then relaying the identified information to the safety driver. For example, a safety engineer may relay certain information about the planned behavior of the AV to the safety driver, such as whether the AV intends to stop, slow down, speed up, or change direction in the near future. As another example, a safety engineer may relay certain information about the AV's perception (or lack thereof) of objects in the AV's surrounding environment to the safety driver. As yet another example, a safety engineer may relay certain information about the AV's prediction of how objects in the AV's surrounding environment will behave in the future to the safety driver. Other examples are possible as well. As with a safety driver, in practice, such a safety engineer could either be a “local” safety engineer who is physically located within the AV or a “remote” safety engineer who is located remotely from the AV but still has the capability to monitor a visualization of information about the operation of the AV's autonomy system via a communication network or the like. (It should also be understood that a remote safety driver and a remote safety engineer may not necessarily be at the same remote location, in which case the communication between the safety driver and the safety engineer may be take place via a communication network as well).

However, while pairing a safety driver with a safety engineer may improve the timeliness and/or accuracy of the safety driver's decisions as to whether to switch AVs from autonomous mode to manual mode, there are also several drawbacks associated with using safety engineers to relay autonomy-system-based information to safety drivers. For instance, one drawback is that, because a safety engineer acts as a middleman between an AV's autonomy system and a safety driver, the safety engineer may introduce delay and/or human error into the presentation of autonomy-system-based information to the safety driver, which may in turn degrade the timeliness and/or accuracy of the safety driver's decisions. Another drawback is that, to the extent that each AV in a fleet of AVs needs to have both a safety driver and a safety engineer, this increases the overall cost of operating the fleet of AVs and could also ultimately limit how many AVs can be operated at any one time, because the number of people qualified to serve in these roles may end up being smaller than the number of available AVs.

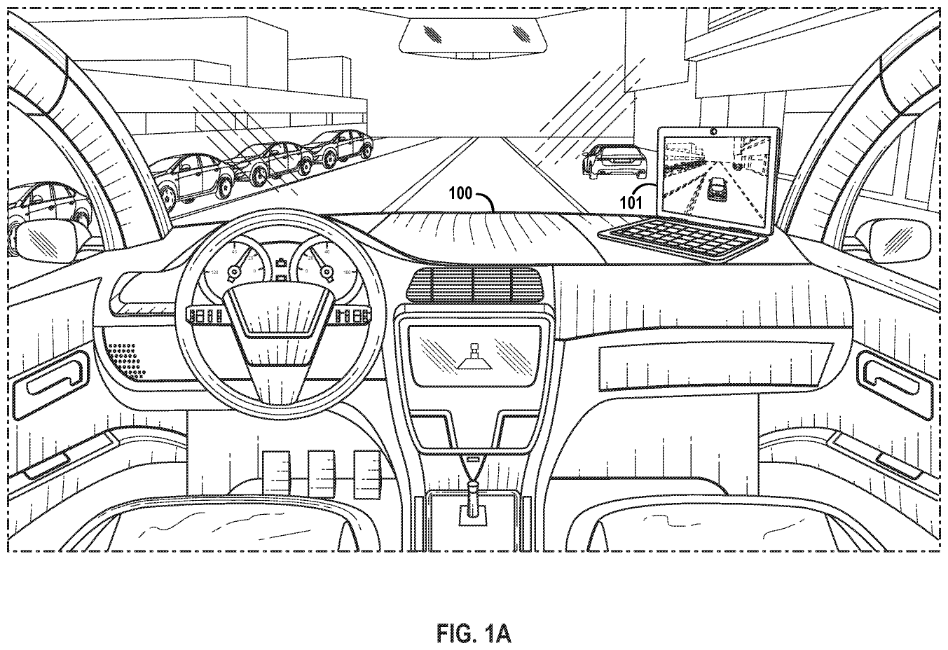

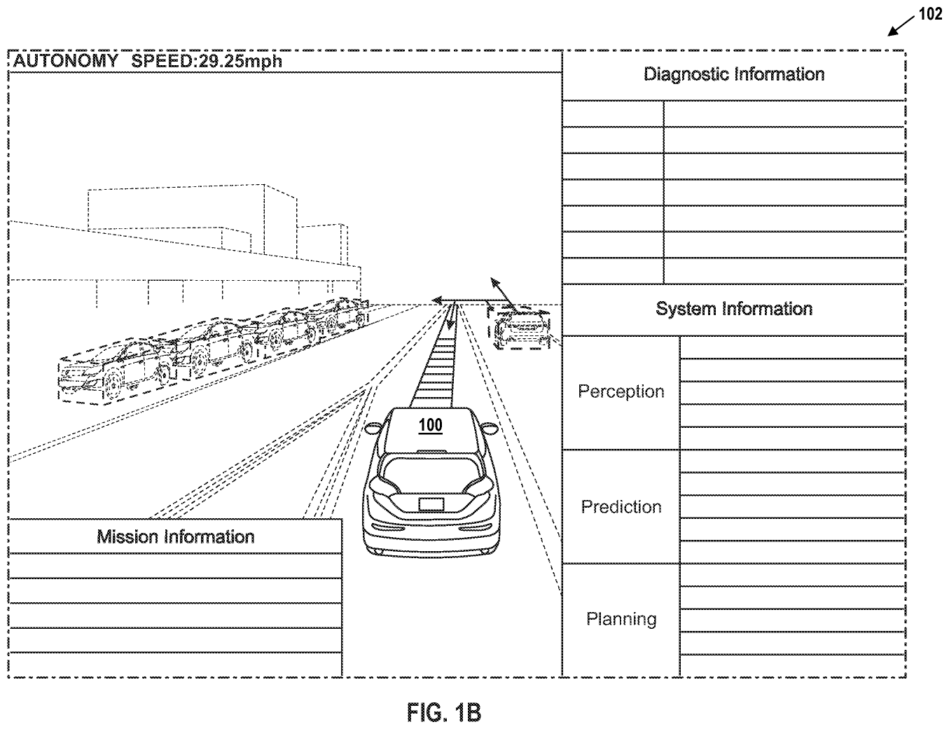

At the same time, it is simply not practical to present a safety driver with the same extent of autonomy-system-based information that would otherwise be presented to as safety engineer, as doing so is likely to overwhelm the safety driver and/or distract from the safety driver's task of monitoring the AV's behavior and real-world surroundings. This problem is highlighted by FIGS. 1A-B, which illustrate one example of how autonomy-system-based information is presently presented to individuals responsible for monitoring the autonomous operation of an AV.

In particular, FIG. 1A illustrates a front interior of an AV 100 that is set up for both a safety driver and a safety engineer, and as shown, this front interior may include a display screen 101 on the safety engineer's side of AV 100 that may be used to present the safety engineer with a visualization of various information about the operation of the AV's autonomy system. In turn, FIG. 1B illustrates one possible example of a visualization 102 that may be presented to the safety engineer via display screen 101 while AV 100 is operating in an autonomous mode. As shown, visualization 102 may include many different pieces of information about the operation of the AV's autonomy system, including but not limited to (i) sensor data that is representative of the surrounding environment perceived by AV 100, which is depicted using dashed lines having smaller dashes, (ii) bounding boxes for every object of interest detected in the AV's surrounding environment, which are depicted using dashed lines having larger dashes, (iii) multiple different predicted trajectories for the moving vehicle detected to the front-right of AV 100, which are depicted as a set of three different arrows extending from the bounding box for the moving object, (iv) the planned trajectory of AV 100, which is depicted as a path extending from the front of AV 100, and (v) various types of detailed textual information about AV 100, including mission information, diagnostic information, and system information.

Given the location of display screen 101 as well as the varied and detailed nature of visualization 102, which is designed for review by a safety engineer rather than a safety driver, it is not feasible to simply remove the safety engineer from AV 100 and shift the responsibility for monitoring visualization 102 to the safety driver. Indeed, doing so would require the safety driver to constantly shift attention back and forth between what is happening in the real world and what is being shown on visualization 102 while at the same time trying to review and make sense of all of the different information shown in visualization 102, which would ultimately end up making the safety driver's job harder rather than easier.

To help address these and other problems, disclosed herein is technology for intelligently presenting autonomy-system-based information for an AV to an individual that is tasked with overseeing the AV's operation within its surrounding environment, such as a local or remote safety driver. At a high level, an AV that incorporates the disclosed technology may function to receive and evaluate data related to the AV's operation within its surrounding environment, extract certain information to present to an individual that is tasked with overseeing the AV's operation within its surrounding environment, and then present such information to the individual via a heads-up display (HUD) system, a speaker system of the AV, and/or some other output system associated with the AV. In this respect, an AV that incorporates the disclosed technology may function to present (i) “baseline” information that is presented regardless of what scenario is currently being faced by the AV, (ii) “scenario-based” information that is presented “on the fly” based on an assessment of the particular scenario that is currently being faced by the AV, or (iii) some combination of baseline and scenario-based information. In this way, an AV that incorporates the disclosed technology has the capability to intelligently present an individual that is tasked with overseeing operation of an AV with a few key pieces of autonomy-system-based information that are most relevant to the current scenario being faced by the AV, which may enable such an individual to monitor the status of the AV's autonomy system (and potentially made decisions based on that autonomy-system status) while at the same time minimizing the risk of overwhelming and/or distracting that individual.

The disclosed technology for determining whether and when to present scenario-based information to an individual that is tasked with overseeing operation of an AV may take various forms. For instance, as one possibility, such technology may involve (i) obtaining data for one or more data variables that characterize a current scenario being faced by an AV while it is operating in autonomous mode, (ii) using the obtained data for the one or more data variables characterizing the current scenario being faced by the AV as a basis for determining whether the current scenario warrants presentation of any scenario-based information to an individual that is tasked with overseeing an AV's operation within its surrounding environment, and then (iii) in response to determining that the current scenario does warrant presentation of scenario-based information, presenting a particular set of scenario-based information to the individual. In this respect, the one or more data variables that that characterize a current scenario being faced by the AV may take various forms, examples of which include a data variable reflecting which predefined scenario types (if any) are currently being faced by the AV, a data variable reflecting a likelihood of the AV making physical contact with another object in the AV's surrounding environment in the foreseeable future, a data variable reflecting an urgency level of the current scenario being faced by the AV, and/or a data variable reflecting a likelihood that a safety driver of the AV (or the like) will decide to switch the AV from autonomous mode to manual mode in the foreseeable future, among other possibilities.

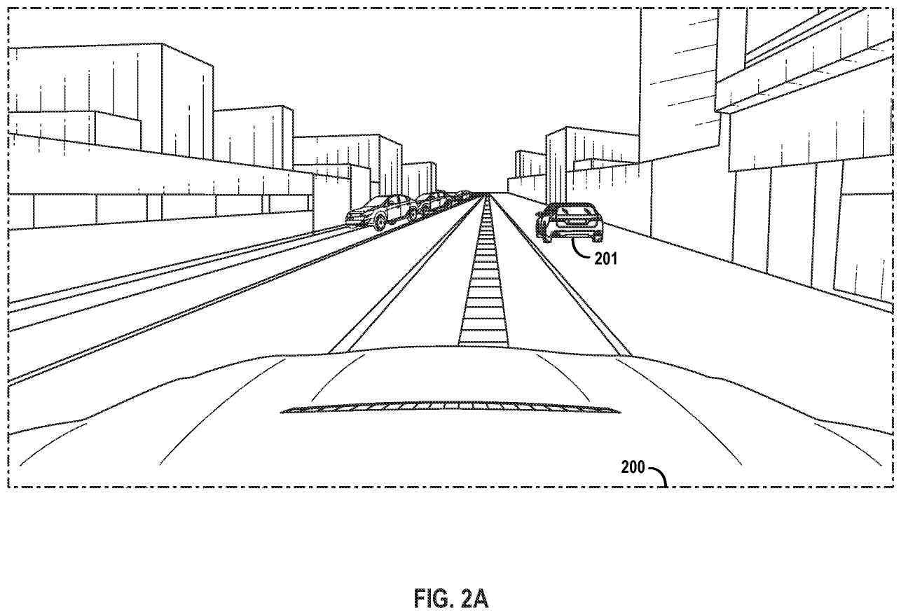

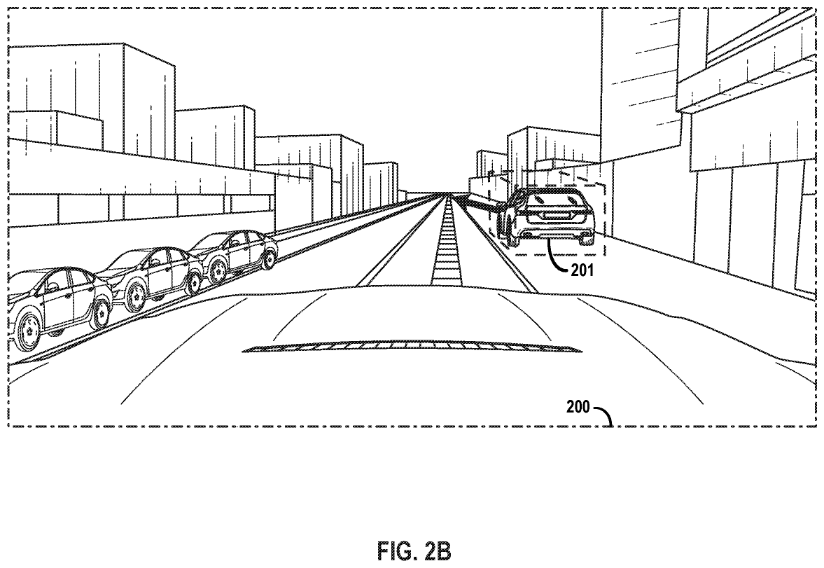

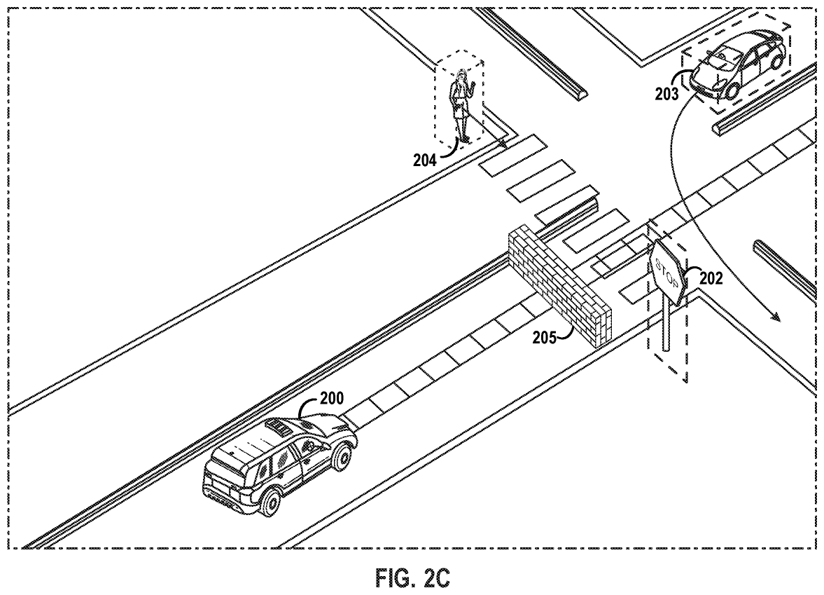

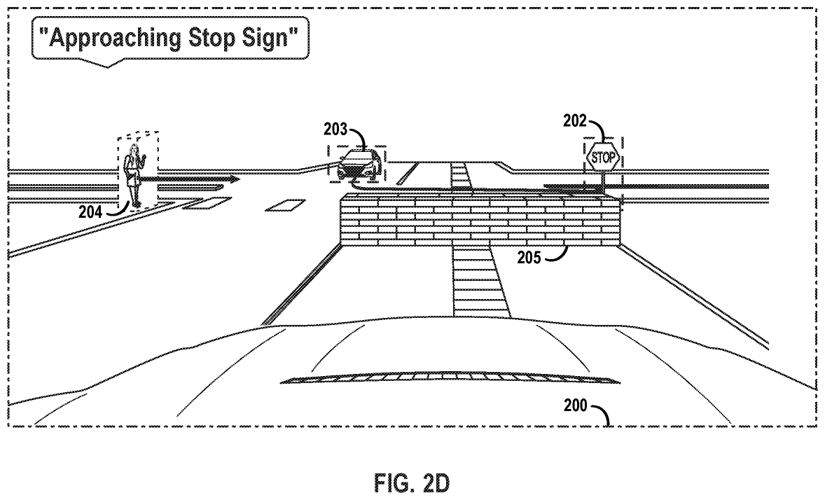

FIGS. 2A-D illustrate some possible examples of how the disclosed technology may be used to intelligently present autonomy-system-based information for an AV to an individual tasked with overseeing the AV's operation within its surrounding environment, such as a local safety driver that is seated in the AV. In particular, FIG. 2A illustrates a view out of a windshield of an example AV 200 at a first time while AV 200 is operating in an autonomous mode in a real-world environment. As shown in FIG. 2A, AV 200 is traveling in a left lane of two-way road and is in proximity to several other vehicles in the AV's surrounding environment, including (i) a moving vehicle 201 ahead of AV 200 that is on the same side of the road and is traveling in the same general direction as AV 200, but is located in the right lane rather than the left lane, as well as (ii) several other vehicles that are parallel parked on the other side of the road.

At the first time shown in FIG. 2A, AV 200 is presenting baseline information via the AV's HUD system that takes the form of a planned trajectory for AV 200, which is displayed as a path extending from the front of AV 200. Additionally, at the first time shown in FIG. 2A, AV 200 has performed an evaluation of the current scenario being faced by AV 200 in order to determine whether to selectively present any scenario-based information to the local safety driver of the AV via the HUD system and/or speaker system of the AV. This may involve an evaluation of factors such as a type of scenario being faced by AV 200, a likelihood of making physical contact with the other vehicles in the AV's surrounding environment in the near future, an urgency level associated with the current scenario, and/or a likelihood that the local safety driver is going to disengage the autonomy system in the near future. Based on such an evaluation, AV 200 may determine that the current scenario at the first time does not warrant presentation of any scenario-based information to the local safety driver at this first time, which may involve a determination that AV 200 is not facing any scenario type that presents an increased risk and/or that the likelihood of AV 200 making physical contact with other objects in the AV's surrounding environment in the near future, the urgency level associated with the current scenario, and/or the likelihood that a safety driver of AV 200 is going to disengage the autonomy system in the near future have values that are not indicative of an increased risk. Thus, at the first time shown in FIG. 2A, AV 200 is not presenting any scenario-based information.

Turning to FIG. 2B, a view out of the windshield of AV 200 is now illustrated at a second time while AV 200 is operating in an autonomous mode in the real-world environment. As shown in FIG. 2B, AV 200 is still traveling in the left lane of the two-way road, and AV 200 has moved forward on that road such that it is now in closer proximity to both moving vehicle 201 and the other vehicles that are parallel parked on the other side of the road.

At this second time shown in FIG. 2B, AV 200 is still presenting the planned trajectory for AV 200 via the HUD system, which is again displayed as a path extending from the front of AV 200. Additionally, at the second time shown in FIG. 2B, AV 200 performs another evaluation of the current scenario being faced by AV 200 in order to determine whether to selectively present any scenario-based information to the local safety driver of the AV, which may again involve an evaluation of factors such as a type of scenario being faced by AV 200, a likelihood of making physical contact with the other vehicles in the AV's surrounding environment in the near future, an urgency level associated with the current scenario, and/or a likelihood that the local safety driver is going to disengage the autonomy system in the near future. Based on such an evaluation, AV 200 may determine that the current scenario at the second time does warrant presentation of certain kinds of scenario-based information to the local safety driver at this second time, which may involve a determination that AV 200 is still not facing any scenario type that presents an increased risk, but that because AV 200 is now in closer proximity to moving vehicle 201, the likelihood of AV 200 making physical contact with other objects in the AV's surrounding environment in the near future, the urgency level associated with the current scenario, and/or the likelihood that a safety driver of AV 200 is going to disengage the autonomy system in the near future have values may be indicative of increased risk. Thus, at the second time shown in FIG. 2B, AV 200 is now presenting a curated set of scenario-based information to the local safety driver that includes a bounding box for moving vehicle 201 and a predicted future trajectory of moving vehicle 201 being displayed via the AV's HUD system.

Turning to FIGS. 2C-D, AV 200 is now illustrated at a third time while AV 200 is operating in an autonomous mode in the real-world environment, where FIG. 2C shows a bird's eye view of the current scenario being faced by AV 200 at the third time and FIG. 2D shows a view out of the windshield of AV 200. As shown in FIGS. 2C-D, AV 200 is now approaching an intersection with a stop sign 202, and there is both a vehicle 203 on the other side of the intersection and a pedestrian 204 that is entering a crosswalk running in front of AV 200.

At this third time shown in FIGS. 2C-D, AV 200 is still presenting the planned trajectory for AV 200 via the HUD system, which is again displayed as a path extending from the front of AV 200. Additionally, at this third time shown in FIGS. 2C-D, AV 200 performs yet another evaluation of the current scenario being faced by AV 200 in order to determine whether to selectively present any scenario-based information to the local safety driver of the AV, which may again involve an evaluation of factors such as a type of scenario being faced by AV 200, a likelihood of making physical contact with the other vehicles in the AV's surrounding environment in the near future, an urgency level associated with the current scenario, and/or a likelihood that the local safety driver is going to disengage the autonomy system in the near future. Based on such an evaluation, AV 200 may determine that the current scenario at the third time does warrant presentation of certain kinds of scenario-based information to the local safety driver at this third time, which may involve a determination that AV 200 is now facing an “approaching a stop-sign intersection” type of scenario that is considered to present an increased risk that the likelihood of AV 200 making physical contact with other objects in the AV's surrounding environment in the near future, the urgency level associated with the current scenario, and/or the likelihood that a safety driver of AV 200 is going to disengage the autonomy system in the near future have values may also be indicative of increased risk. Thus, at the third time shown in FIGS. 2C-D, AV 200 is now presenting another curated set of scenario-based information to the local safety driver, which comprises both visual information output via the AV's HUD system that includes a bounding box for stop sign 202, a bounding box and predicted future trajectory for vehicle 203, a bounding box and predicted future trajectory for pedestrian 204, and a stop wall 205 that indicates where AV 200 plans to stop for the stop sign, as well as audio information output via the AV's speaker system notifying the local safety driver that AV 200 has detected an “approaching a stop-sign intersection” type of scenario.

While the FIGS. 2A-D illustrate some possible examples of scenario-based information that may be presented to a local safety driver, it should be understood that the scenario-based information that may be presented to a safety driver (or some other individual tasked with overseeing operation of an AV) may take various other forms as well.

Advantageously, by presenting this curated set of scenario-based information to a safety driver of AV 200, the disclosed technology may enable the safety driver to monitor the status of the AV's autonomy system—which may help the safety driver make a timely and accurate decision as to whether to switch AV 200 from autonomous mode to manual mode in the near future—while at the same time minimizing the risk of overwhelming and/or distracting the safety driver with extraneous information that is not particularly relevant to the safety driver's task. As discussed in detail below, the disclosed technology may take various other forms and provide various other benefits as well.

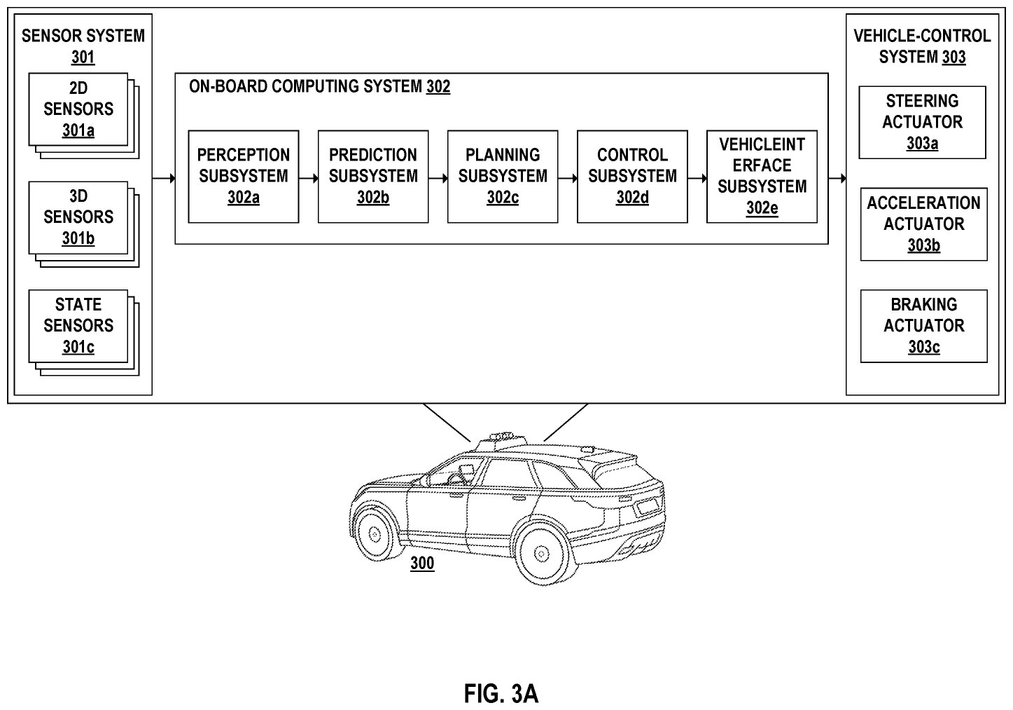

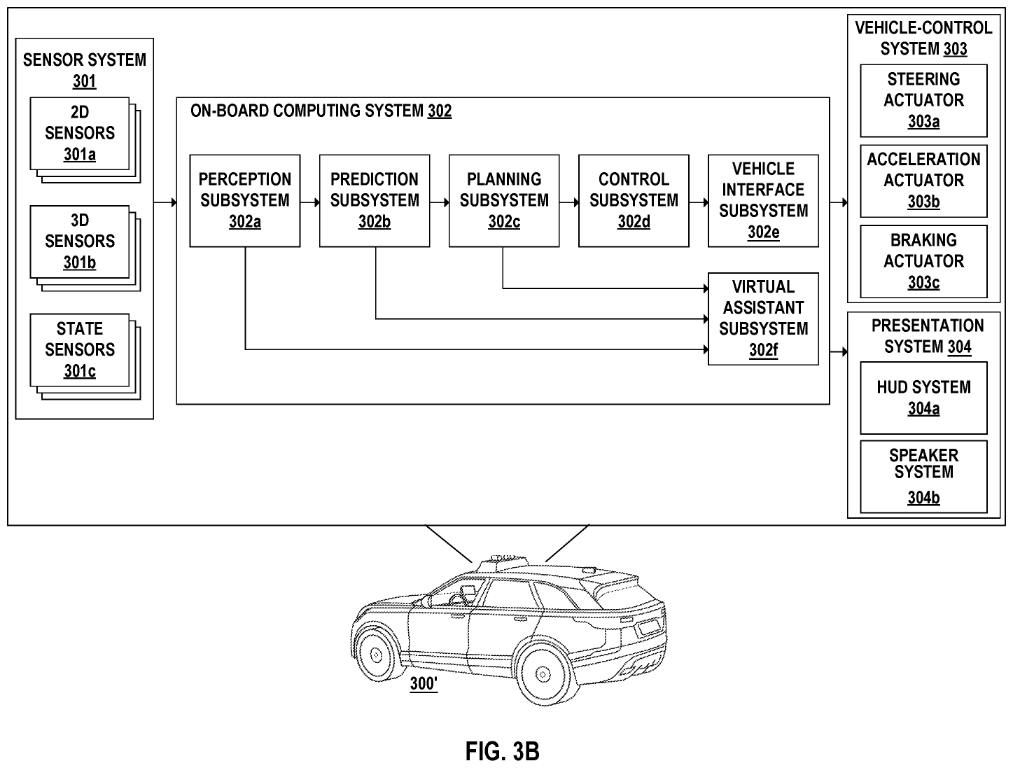

Turning now to FIG. 3A, a simplified block diagram is provided to illustrate certain systems that may be included in an example AV 300. As shown, at a high level, AV 300 may include at least a (i) sensor system 301 that is configured to capture sensor data that is representative of the real-world environment being perceived by the AV (i.e., the AV's “surrounding environment”) and/or the AV's operation within that real-world environment, (ii) an on-board computing system 302 that is configured to perform functions related to autonomous operation of AV 300 (and perhaps other functions as well), and (iii) a vehicle-control system 303 that is configured to control the physical operation of AV 300, among other possibilities. Each of these AV systems may take various forms.

In general, sensor system 301 may comprise any of various different types of sensors, each of which is generally configured to detect one or more particular stimuli based on AV 300 operating in a real-world environment and then output sensor data that is indicative of one or more measured values of the one or more stimuli at one or more capture times (which may each comprise a single instant of time or a range of times).

For instance, as one possibility, sensor system 301 may include one or more two-dimensional (2D) sensors 301a that are each configured to capture 2D data that is representative of the AV's surrounding environment. Examples of 2D sensor(s) 301a may include a 2D camera array, a 2D Radio Detection and Ranging (RADAR) unit, a 2D Sound Navigation and Ranging (SONAR) unit, a 2D ultrasound unit, a 2D scanner, and/or 2D sensors equipped with visible-light and/or infrared sensing capabilities, among other possibilities. Further, in an example implementation, 2D sensor(s) 301a comprise have an arrangement that is capable of capturing 2D sensor data representing a 360° view of the AV's surrounding environment, one example of which may take the form of an array of 6-7 cameras that each have a different capture angle. Other 2D sensor arrangements are also possible.

As another possibility, sensor system 301 may include one or more three-dimensional (3D) sensors 301b that are each configured to capture 3D data that is representative of the AV's surrounding environment. Examples of 3D sensor(s) 301b may include a Light Detection and Ranging (LIDAR) unit, a 3D RADAR unit, a 3D SONAR unit, a 3D ultrasound unit, and a camera array equipped for stereo vision, among other possibilities. Further, in an example implementation, 3D sensor(s) 301b may comprise an arrangement that is capable of capturing 3D sensor data representing a 360° view of the AV's surrounding environment, one example of which may take the form of a LIDAR unit that is configured to rotate 360° around its installation axis. Other 3D sensor arrangements are also possible.

As yet another possibility, sensor system 301 may include one or more state sensors 301c that are each configured to detect aspects of the AV's current state, such as the AV's current position, current orientation (e.g., heading/yaw, pitch, and/or roll), current velocity, and/or current acceleration of AV 300. Examples of state sensor(s) 301c may include an Inertial Measurement Unit (IMU) (which may be comprised of accelerometers, gyroscopes, and/or magnetometers), an Inertial Navigation System (INS), a Global Navigation Satellite System (GNSS) unit such as a Global Positioning System (GPS) unit, among other possibilities.

Sensor system 301 may include various other types of sensors as well.

In turn, on-board computing system 302 may generally comprise any computing system that includes at least a communication interface, a processor, and data storage, where such components may either be part of a single physical computing device or be distributed across a plurality of physical computing devices that are interconnected together via a communication link. Each of these components may take various forms.

For instance, the communication interface of on-board computing system 302 may take the form of any one or more interfaces that facilitate communication with other systems of AV 300 (e.g., sensor system 303 and vehicle-control system 303) and/or remote computing systems (e.g., a ride-services management system), among other possibilities. In this respect, each such interface may be wired and/or wireless and may communicate according to any of various communication protocols, examples of which may include Ethernet, Wi-Fi, Controller Area Network (CAN) bus, serial bus (e.g., Universal Serial Bus (USB) or Firewire), cellular network, and/or short-range wireless protocols.

Further, the processor of on-board computing system 302 may comprise one or more processor components, each of which may take the form of a general-purpose processor (e.g., a microprocessor), a special-purpose processor (e.g., an application-specific integrated circuit, a digital signal processor, a graphics processing unit, a vision processing unit, etc.), a programmable logic device (e.g., a field-programmable gate array), or a controller (e.g., a microcontroller), among other possibilities.

Further yet, the data storage of on-board computing system 302 may comprise one or more non-transitory computer-readable mediums, each of which may take the form of a volatile medium (e.g., random-access memory, a register, a cache, a buffer, etc.) or a non-volatile medium (e.g., read-only memory, a hard-disk drive, a solid-state drive, flash memory, an optical disk, etc.), and these one or more non-transitory computer-readable mediums may be capable of storing both (i) program instructions that are executable by the processor of on-board computing system 302 such that on-board computing system 302 is configured to perform various functions related to the autonomous operation of AV 300 (among other possible functions), and (ii) data that may be obtained, derived, or otherwise stored by on-board computing system 302.

In one embodiment, on-board computing system 302 may also be functionally configured into a number of different subsystems that are each tasked with performing a specific subset of functions that facilitate the autonomous operation of AV 300, and these subsystems may be collectively referred to as the AV's “autonomy system.” In practice, each of these subsystems may be implemented in the form of program instructions that are stored in the on-board computing system's data storage and are executable by the on-board computing system's processor to carry out the subsystem's specific subset of functions, although other implementations are possible as well—including the possibility that different subsystems could be implemented via different hardware components of on-board computing system 302.

As shown in FIG. 3A, in one embodiment, the functional subsystems of on-board computing system 302 may include (i) a perception subsystem 302a that generally functions to derive a representation of the surrounding environment being perceived by AV 300, (ii) a prediction subsystem 302b that generally functions to predict the future state of each object detected in the AV's surrounding environment, (iii) a planning subsystem 302c that generally functions to derive a behavior plan for AV 300, (iv) a control subsystem 302d that generally functions to transform the behavior plan for AV 300 into control signals for causing AV 300 to execute the behavior plan, and (v) a vehicle-interface subsystem 302e that generally functions to translate the control signals into a format that vehicle-control system 303 can interpret and execute. However, it should be understood that the functional subsystems of on-board computing system 302 may take various forms as well. Each of these example subsystems will now be described in further detail below.

For instance, the subsystems of on-board computing system 302 may begin with perception subsystem 302a, which may be configured to fuse together various different types of “raw” data that relates to the AV's perception of its surrounding environment and thereby derive a representation of the surrounding environment being perceived by AV 300. In this respect, the raw data that is used by perception subsystem 302a to derive the representation of the AV's surrounding environment may take any of various forms.

For instance, at a minimum, the raw data that is used by perception subsystem 302a may include multiple different types of sensor data captured by sensor system 301, such as 2D sensor data (e.g., image data) that provides a 2D representation of the AV's surrounding environment, 3D sensor data (e.g., LIDAR data) that provides a 3D representation of the AV's surrounding environment, and/or state data for AV 300 that indicates the past and current position, orientation, velocity, and acceleration of AV 300. Additionally, the raw data that is used by perception subsystem 302a may include map data associated with the AV's location, such as high-definition geometric and/or semantic map data, which may be preloaded onto on-board computing system 302 and/or obtained from a remote computing system. Additionally yet, the raw data that is used by perception subsystem 302a may include navigation data for AV 400 that indicates a specified origin and/or specified destination for AV 400, which may be obtained from a remote computing system (e.g., a ride-services management system) and/or input by a human riding in AV 400 via a user-interface component that is communicatively coupled to on-board computing system 302. Additionally still, the raw data that is used by perception subsystem 302a may include other types of data that may provide context for the AV's perception of its surrounding environment, such as weather data and/or traffic data, which may obtained from a remote computing system. The raw data that is used by perception subsystem 302a may include other types of data as well.

Advantageously, by fusing together multiple different types of raw data (e.g., both 2D sensor data and 3D sensor data), perception subsystem 302a is able to leverage the relative strengths of these different types of raw data in way that may produce a more accurate and precise representation of the surrounding environment being perceived by AV 300.

Further, the function of deriving the representation of the surrounding environment perceived by AV 300 using the raw data may include various aspects. For instance, one aspect of deriving the representation of the surrounding environment perceived by AV 300 using the raw data may involve determining a current state of AV 300 itself, such as a current position, a current orientation, a current velocity, and/or a current acceleration, among other possibilities. In this respect, perception subsystem 302a may also employ a localization technique such as Simultaneous Localization and Mapping (SLAM) to assist in the determination of the AV's current position and/or orientation. (Alternatively, it is possible that on-board computing system 302 may run a separate localization service that determines position and/or orientation values for AV 300 based on raw data, in which case these position and/or orientation values may serve as another input to perception subsystem 302a).

Another aspect of deriving the representation of the surrounding environment perceived by AV 300 using the raw data may involve detecting objects within the AV's surrounding environment, which may result in the determination of class labels, bounding boxes, or the like for each detected object. In this respect, the particular classes of objects that are detected by perception subsystem 302a (which may be referred to as “agents”) may take various forms, including both (i) “dynamic” objects that have the potential to move, such as vehicles, cyclists, pedestrians, and animals, among other examples, and (ii) “static” objects that generally do not have the potential to move, such as streets, curbs, lane markings, traffic lights, stop signs, and buildings, among other examples. Further, in practice, perception subsystem 302a may be configured to detect objects within the AV's surrounding environment using any type of object detection model now known or later developed, including but not limited object detection models based on convolutional neural networks (CNN).

Yet another aspect of deriving the representation of the surrounding environment perceived by AV 300 using the raw data may involve determining a current state of each object detected in the AV's surrounding environment, such as a current position (which could be reflected in terms of coordinates and/or in terms of a distance and direction from AV 300), a current orientation, a current velocity, and/or a current acceleration of each detected object, among other possibilities. In this respect, the current state each detected object may be determined either in terms of an absolute measurement system or in terms of a relative measurement system that is defined relative to a state of AV 300, among other possibilities.

The function of deriving the representation of the surrounding environment perceived by AV 300 using the raw data may include other aspects as well.

Further yet, the derived representation of the surrounding environment perceived by AV 300 may incorporate various different information about the surrounding environment perceived by AV 300, examples of which may include (i) a respective set of information for each object detected in the AV's surrounding, such as a class label, a bounding box, and/or state information for each detected object, (ii) a set of information for AV 300 itself, such as state information and/or navigation information (e.g., a specified destination), and/or (iii) other semantic information about the surrounding environment (e.g., time of day, weather conditions, traffic conditions, etc.). The derived representation of the surrounding environment perceived by AV 300 may incorporate other types of information about the surrounding environment perceived by AV 300 as well.

Still further, the derived representation of the surrounding environment perceived by AV 300 may be embodied in various forms. For instance, as one possibility, the derived representation of the surrounding environment perceived by AV 300 may be embodied in the form of a data structure that represents the surrounding environment perceived by AV 300, which may comprise respective data arrays (e.g., vectors) that contain information about the objects detected in the surrounding environment perceived by AV 300, a data array that contains information about AV 300, and/or one or more data arrays that contain other semantic information about the surrounding environment. Such a data structure may be referred to as a “parameter-based encoding.”

As another possibility, the derived representation of the surrounding environment perceived by AV 300 may be embodied in the form of a rasterized image that represents the surrounding environment perceived by AV 300 in the form of colored pixels. In this respect, the rasterized image may represent the surrounding environment perceived by AV 300 from various different visual perspectives, examples of which may include a “top down” view and a “birds eye” view of the surrounding environment, among other possibilities. Further, in the rasterized image, the objects detected in the surrounding environment of AV 300 (and perhaps AV 300 itself) could be shown as color-coded bitmasks and/or bounding boxes, among other possibilities.

The derived representation of the surrounding environment perceived by AV 300 may be embodied in other forms as well.

As shown, perception subsystem 302a may pass its derived representation of the AV's surrounding environment to prediction subsystem 302b. In turn, prediction subsystem 302b may be configured to use the derived representation of the AV's surrounding environment (and perhaps other data) to predict a future state of each object detected in the AV's surrounding environment at one or more future times (e.g., at each second over the next 5 seconds)—which may enable AV 300 to anticipate how the real-world objects in its surrounding environment are likely to behave in the future and then plan its behavior in a way that accounts for this future behavior.

Prediction subsystem 302b may be configured to predict various aspects of a detected object's future state, examples of which may include a predicted future position of the detected object, a predicted future orientation of the detected object, a predicted future velocity of the detected object, and/or predicted future acceleration of the detected object, among other possibilities. In this respect, if prediction subsystem 302b is configured to predict this type of future state information for a detected object at multiple future times, such a time sequence of future states may collectively define a predicted future trajectory of the detected object. Further, in some embodiments, prediction subsystem 302b could be configured to predict multiple different possibilities of future states for a detected (e.g., by predicting the 3 most-likely future trajectories of the detected object). Prediction subsystem 302b may be configured to predict other aspects of a detected object's future behavior as well.

In practice, prediction subsystem 302b may predict a future state of an object detected in the AV's surrounding environment in various manners, which may depend in part on the type of detected object. For instance, as one possibility, prediction subsystem 302b may predict the future state of a detected object using a data science model that is configured to (i) receive input data that includes one or more derived representations output by perception subsystem 302a at one or more perception times (e.g., the “current” perception time and perhaps also one or more prior perception times), (ii) based on an evaluation of the input data, which includes state information for the objects detected in the AV's surrounding environment at the one or more perception times, predict at least one likely time sequence of future states of the detected object (e.g., at least one likely future trajectory of the detected object), and (iii) output an indicator of the at least one likely time sequence of future states of the detected object. This type of data science model may be referred to herein as a “future-state model.”

Such a future-state model will typically be created by an off-board computing system (e.g., a backend data processing system) and then loaded onto on-board computing system 302, although it is possible that a future-state model could be created by on-board computing system 302 itself. Either way, the future-state may be created using any modeling technique now known or later developed, including but not limited to a machine-learning technique that may be used to iteratively “train” the data science model to predict a likely time sequence of future states of an object based on training data that comprises both test data (e.g., historical representations of surrounding environments at certain historical perception times) and associated ground-truth data (e.g., historical state data that indicates the actual states of objects in the surrounding environments during some window of time following the historical perception times).

Prediction subsystem 302b could predict the future state of a detected object in other manners as well. For instance, for detected objects that have been classified by perception subsystem 302a as belonging to certain classes of static objects (e.g., roads, curbs, lane markings, etc.), which generally do not have the potential to move, prediction subsystem 302b may rely on this classification as a basis for predicting that the future state of the detected object will remain the same at each of the one or more future times (in which case the state-prediction model may not be used for such detected objects). However, it should be understood that detected objects may be classified by perception subsystem 302a as belonging to other classes of static objects that have the potential to change state despite not having the potential to move, in which case prediction subsystem 302b may still use a future-state model to predict the future state of such detected objects. One example of a static object class that falls within this category is a traffic light, which generally does not have the potential to move but may nevertheless have the potential to change states (e.g. between green, yellow, and red) while being perceived by AV 300.

After predicting the future state of each object detected in the surrounding environment perceived by AV 300 at one or more future times, prediction subsystem 302b may then either incorporate this predicted state information into the previously-derived representation of the AV's surrounding environment (e.g., by adding data arrays to the data structure that represents the surrounding environment) or derive a separate representation of the AV's surrounding environment that incorporates the predicted state information for the detected objects, among other possibilities.

As shown, prediction subsystem 302b may pass the one or more derived representations of the AV's surrounding environment to planning subsystem 302c. In turn, planning subsystem 302c may be configured to use the one or more derived representations of the AV's surrounding environment (and perhaps other data) to derive a behavior plan for AV 300, which defines the desired driving behavior of AV 300 for some future period of time (e.g., the next 5 seconds).

The behavior plan that is derived for AV 300 may take various forms. For instance, as one possibility, the derived behavior plan for AV 300 may comprise a planned trajectory for AV 300 that specifies a planned state of AV 300 at each of one or more future times (e.g., each second over the next 5 seconds), where the planned state for each future time may include a planned position of AV 300 at the future time, a planned orientation of AV 300 at the future time, a planned velocity of AV 300 at the future time, and/or a planned acceleration of AV 300 (whether positive or negative) at the future time, among other possible types of state information. As another possibility, the derived behavior plan for AV 300 may comprise one or more planned actions that are to be performed by AV 300 during the future window of time, where each planned action is defined in terms of the type of action to be performed by AV 300 and a time and/or location at which AV 300 is to perform the action, among other possibilities. The derived behavior plan for AV 300 may define other planned aspects of the AV's behavior as well.

Further, in practice, planning subsystem 302c may derive the behavior plan for AV 300 in various manners. For instance, as one possibility, planning subsystem 302c may be configured to derive the behavior plan for AV 300 by (i) deriving a plurality of different “candidate” behavior plans for AV 300 based on the one or more derived representations of the AV's surrounding environment (and perhaps other data), (ii) evaluating the candidate behavior plans relative to one another (e.g., by scoring the candidate behavior plans using one or more cost functions) in order to identify which candidate behavior plan is most desirable when considering factors such as proximity to other objects, velocity, acceleration, time and/or distance to destination, road conditions, weather conditions, traffic conditions, and/or traffic laws, among other possibilities, and then (iii) selecting the candidate behavior plan identified as being most desirable as the behavior plan to use for AV 300. Planning subsystem 302c may derive the behavior plan for AV 300 in various other manners as well.

After deriving the behavior plan for AV 300, planning subsystem 302c may pass data indicating the derived behavior plan to control subsystem 302d. In turn, control subsystem 302d may be configured to transform the behavior plan for AV 300 into one or more control signals (e.g., a set of one or more command messages) for causing AV 300 to execute the behavior plan. For instance, based on the behavior plan for AV 300, control subsystem 302d may be configured to generate control signals for causing AV 300 to adjust its steering in a specified manner, accelerate in a specified manner, and/or brake in a specified manner, among other possibilities.

As shown, control subsystem 302d may then pass the one or more control signals for causing AV 300 to execute the behavior plan to vehicle-interface 302e. In turn, vehicle-interface system 302e may be configured to translate the one or more control signals into a format that can be interpreted and executed by components of vehicle-control system 303. For example, vehicle-interface system 302e may be configured to translate the one or more control signals into one or more control messages are defined according to a particular format or standard, such as a CAN bus standard and/or some other format or standard that is used by components of vehicle-control system 303.

In turn, vehicle-interface subsystem 302e may be configured to direct the one or more control signals to the appropriate control components of vehicle-control system 303. For instance, as shown, vehicle-control system 303 may include a plurality of actuators that are each configured to control a respective aspect of the AV's physical operation, such as a steering actuator 303a that is configured to control the vehicle components responsible for steering (not shown), an acceleration actuator 303b that is configured to control the vehicle components responsible for acceleration such as a throttle (not shown), and a braking actuator 303c that is configured to control the vehicle components responsible for braking (not shown), among other possibilities. In such an arrangement, vehicle-interface subsystem 302e of on-board computing system 302 may be configured to direct steering-related control signals to steering actuator 303a, acceleration-related control signals to acceleration actuator 303b, and braking-related control signals to braking actuator 303c. However, it should be understood that the control components of vehicle-control system 303 may take various other forms as well.

Notably, the subsystems of on-board computing system 302 may be configured to perform the above functions in a repeated manner, such as many times per second, which may enable AV 300 to continually update both its understanding of the surrounding environment and its planned behavior within that surrounding environment.

In accordance with the present disclosure, example AV 300 may be adapted to include additional technology that enables autonomy-system-based information for AV 300 to be intelligently presented to an individual that is tasked with overseeing the AV's operation within its surrounding environment (e.g., a safety driver or the like). One possible embodiment of the disclosed technology is illustrated in FIG. 3B, which is a simplified block diagram of example systems that may be included in an example AV 300′ that is configured in accordance with the present disclosure. In FIG. 3B, AV 300′ is shown to include all of the same systems and functional subsystems of FIG. 3A (which are denoted using the same reference numbers), as well as an additional vehicle-presentation system 304 and an additional functional subsystem of on-board computing system 302 that is referred to as “virtual-assistant” subsystem 302f These additional elements of AV 300′ will now be described in further detail.

In general, vehicle-presentation system 304 may comprise any one or more systems that are capable of outputting information to an individual physically located within AV 300′, such as a local safety driver. For instance, as shown, vehicle-presentation system 304 may comprise (i) a HUD system 304a that is configured to output visual information to an individual physically located within AV 300′ by projecting such information onto the AV's windshield and/or (ii) a speaker system 304b that is configured to output audio information to an individual physically located within AV 300′ by playing such information aloud. However, it should be understood that vehicle-presentation system 304 may take other forms as well, including but not limited the possibility that vehicle-presentation system 304 may comprise only one of the example output systems shown in FIG. 3B and/or that vehicle-presentation system 304 may include another type of output system as well (e.g., a display screen included as part of the AV's control console). Further, while driver-presentation system 304 is depicted as a separate system from on-board computing system 302, it should be understood that driver-presentation system 304 may be integrated in whole or in part with on-board computing system 302.

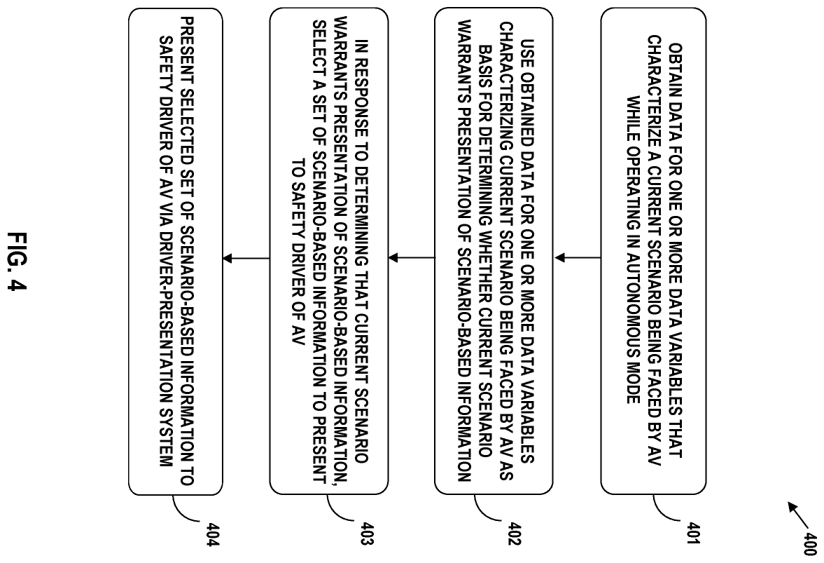

In turn, virtual-assistant subsystem 302f may generally function to receive and evaluate data related to the AV's surrounding environment and its operation therein, extract information to present to an individual tasked with overseeing the operation of AV 300′ (e.g., a safety driver), and then present such information to that individual via vehicle-presentation system 304 (e.g., by instructing HUD system 304a and/or speaker system 304b to output the information). For instance, in accordance with one aspect of the disclosed technology, virtual-assistant subsystem 302f may function to present certain “baseline” information regardless of the particular scenario being faced by AV 300′, in which case this baseline information may be presented throughout the entire time that AV 300′ is operating in an autonomous mode (or at least the entire time that the baseline information is available for presentation). Such baseline information could take any of various forms (including but not limited to the forms described below in connection with FIG. 4), and one representative example of such baseline information may comprise the planned trajectory of AV 300′. Further, in accordance with another aspect of the disclosed technology, virtual-assistant subsystem 302f may function to dynamically select and present certain scenario-based information based on the particular scenario that is currently being faced by AV 300′. This aspect of the disclosed technology is described in further detail below in connection with FIG. 4. The virtual-assistant subsystem's selection and presentation of information make take other forms as well.

Virtual-assistant subsystem 302f could be configured to perform other functions to assist an individual tasked with overseeing the operation of AV 300′ as well. For instance, as one possibility, virtual-assistant subsystem 302f could be configured to receive, process, and respond to questions asked by an individual tasked with overseeing the operation of AV 300′ such as a safety driver, which may involve the use of natural language processing (NLP) or the like. As another possibility, virtual-assistant subsystem 302f could be configured to automatically seek remote assistance when certain circumstances are detected. As yet another possibility, virtual-assistant subsystem 302f could be configured to interface with passengers of AV 300′ so that an individual tasked with overseeing the operation of AV 300′ can remain focused on monitoring the AV's surrounding environment and its operation therein. The functions that are performed by virtual-assistant subsystem 302f to assist an individual tasked with overseeing the operation of AV 300′ may take other forms as well.

As with the on-board computing system's other functional subsystems, virtual-assistant subsystem 302f may be implemented in the form of program instructions that are stored in the on-board computing system's data storage and are executable by the on-board computing system's processor to carry out the virtual-assistance functions disclosed herein. However, other implementations of virtual-assistant subsystem 302f possible as well, including the possibility that virtual-assistant subsystem 302f could be split between on-board computing system 302 and driver-presentation system 304.

While one possible implementation of the disclosed technology is described above in connection with FIG. 3B, it should be understood that the disclosed technology may also be embodied in other forms. As one possibility, instead of being embodied in the form of on-board hardware and/or software of an AV, the disclosed technology may be embodied at least in part in the form off-board hardware and/or software. For example, in line with the discussion above, it is possible that an individual tasked with overseeing an AV's operation in its surrounding environment may located remotely from the AV (e.g., a remote safety driver), in which case the disclosed technology may be implemented in the form of one or more off-board output systems (e.g., an off-board display screen and/or speaker system) that are capable of outputting information to an individual located remotely from the AV based on instructions from an virtual-assistant subsystem, which may be implemented either as part of the AV's on-board computing system or as part of an off-board computing system that is communicatively coupled to the AV's on-board computing system via a communication network. The disclosed technology may be embodied in other forms as well.

Referring now to FIG. 4, a functional block diagram 400 is provided that illustrates one example embodiment of the disclosed technology for intelligently presenting an individual tasked with overseeing operation of an AV with a set of information related to a current scenario being faced by the AV. For the purposes of illustration, the example operations are described below as being carried out by on-board computing system 302 of AV 300′ illustrated in FIG. 3B in order to present information to a safety driver, but it should be understood that a computing system other than on-board computing system 302 may perform the example operations and that the information may be presented to an individual other than a safety driver. Likewise, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 4, the disclosed process may begin at block 401 with on-board computing system 302 obtaining data for one or more data variables that characterize a current scenario being faced by AV 300′ while it is operating in autonomous mode, which may be referred to herein as “scenario variables.” In this respect, the one or more scenario variables may take various forms. For instance, in accordance with the present disclosure, the one or more scenario variables for AV 300′ may include one or more of (i) a data variable reflecting which predefined scenario types (if any) are currently being faced by AV 300′, (ii) a data variable reflecting a likelihood of AV 300′ making physical contact with another object in the AV's surrounding environment in the foreseeable future, (iii) a data variable reflecting an urgency level of the current scenario being faced by AV 300′, and (iv) a data variable reflecting a likelihood that the safety driver will decide to switch AV 300′ from autonomous mode to manual mode in the foreseeable future. The form and manner of obtaining data for each of these different types of scenario variables will now be described in further detail.

For instance, at block 401, on-board computing system 302 may obtain data for a scenario variable that reflects which predefined scenario types (if any) are currently being faced by AV 300′, which may be referred to herein as a “scenario-type variable.” In this respect, on-board computing system 302 may maintain or otherwise have access to a set of predefined scenario types that could potentially be faced by an AV, and these predefined scenario types could take any of various forms. For example, the set of predefined scenario types could include an “approaching a traffic-light intersection” type of scenario, an “approaching a stop-sign intersection” type of scenario, a “following behind lead vehicle” type of scenario, a “pedestrian or cyclist ahead” type of scenario, a “vehicle has cut in front” type of scenario, and/or a “changing lanes” type of scenario, among various other possibilities. In some embodiments, it is also possible for predefined scenario types such as those mentioned above to be represented at a more granular level (e.g., the “approaching a traffic-light intersection” type of scenario may be broken down into “approaching a red traffic light,” “approaching a yellow traffic light,” and “approaching a green traffic light” scenario types). The predefined scenario types may take other forms as well. Further, in practice, the scenario-type variable's value may take various forms, examples of which may include a textual descriptor, an alphanumeric code, or the like for each predefined scenario type currently being faced by AV 300′.

On-board computing system 302 may obtain a value of the scenario-type variable for the current scenario faced by AV 300′ in various manners. In one implementation, on-board computing system 302 may obtain a value of the scenario-type variable for the current scenario faced by AV 300′ using a data science model that is configured to (i) receive input data that is potentially indicative of which predefined scenario types are being faced by an AV at a given time, (ii) based on an evaluation of the input data, predict which of the predefined scenario types (if any) are likely being faced by the AV at the given time, and (iii) output a value that indicates each scenario type identified as a result of the model's prediction (where this value may indicate that the AV is likely not facing any of the predefined scenario types at the given time, that the AV is likely facing one particular scenario type at the given time, or that the AV is likely facing multiple different scenario types at the given time). This data science model may be referred to herein as a “scenario-type model.”

In practice, such a scenario-type model will typically be created by an off-board computing system (e.g., a backend data processing system) and then loaded onto an AV's on-board computing system, although it is possible that a scenario-type model could be created by the AV's on-board computing system itself. Either way, the scenario-type model may be created using any modeling approach now known or later developed. For instance, as one possibility, the scenario-type model may be created by using one or more machine-learning techniques to “train” the scenario-type model to predict which of the predefined scenario types are likely being faced by an AV based on training data. In this respect, the training data for the scenario-type model may take various forms. For instance, as one possibility, such training data may comprise respective sets of historical input data associated with each different predefined scenario type, such as a first historical input dataset associated with scenarios in which an AV is known to have been facing a first scenario type, a second historical input dataset associated with scenarios in which an AV is known to have been facing a second scenario type, and so on. The training data for the scenario-type model may also take various other forms, including the possibility that the training data may include simulated input data instead of (or in addition to) historical input data. Likewise, the one or more machine-learning techniques used to train the scenario-type model may take any of various forms, examples of which may include a regression technique, a neural-network technique, a k-Nearest Neighbor (kNN) technique, a decision-tree technique, a support-vector-machines (SVM) technique, a Bayesian technique, an ensemble technique, a clustering technique, an association-rule-learning technique, and/or a dimensionality-reduction technique, among other possibilities.

However, it should be understood that a scenario-type model may be created in other manners as well, including the possibility that the scenario-type model may be coded by a data scientist (or the like) rather than being derived using a machine-learning technique. Likewise, it should be understood that the scenario-type model may also be updated periodically (e.g., based on newly-available historical input data).

The input data for the scenario-type model may take any of various forms. As one possibility, the input data for the scenario-type model may include certain types of raw data available to the AV, examples of which may include any of various types of sensor data captured by the AV (e.g., 2D sensor data, 3D sensor data, IMU/INS/GNSS data, etc.), map data associated with the AV's location (e.g., geometric and/or semantic map data), and/or other types of raw data that provides context for the AV's perception of its surrounding environment (e.g., weather data, traffic data, etc.), among other examples.

As another possibility, the input data for the scenario-type model may include certain types of “derived” data that is derived by the AV based on the types of raw data discussed above. For instance, in line with the discussion above, an AV may have an autonomy system that is configured to derive data indicating a class and current state of the objects detected in the AV's surrounding environment (e.g., a current position, current orientation, and current motion state of each such object), a predicted future state of the objects detected in the AV's surrounding environment (e.g., one or more future positions, future orientations, and future motion states of each such object), and/or a planned trajectory of the AV, among other examples, and at least some of this derived data may then serve as input data for the scenario-type model.

The input data for the scenario-type model may take other forms as well, including but not limited to the possibility that the input data for the scenario-type model may comprise some combination of the foregoing categories of data.

Further, the manner in which the scenario-type model predicts which of the predefined scenario types are likely being faced by the AV at the given time may take various forms. As one possibility, the scenario-type model may begin by predicting, for each of the predefined scenario types, a respective likelihood that the predefined scenario type is being faced by the AV at the given time (e.g., a probability value on a scale from 0 to 100 or 0.0 to 1.0). In this respect, the scenario-type model's prediction of a likelihood that any individual scenario type is being faced by the AV may be based on various features that may be included within (or otherwise be derived from) the input data, examples of which may include the types of objects detected in the surrounding environment, the current and/or predicted future state of the objects detected in the surrounding environment, and/or map data for the area in which the AV is located (e.g., geometric and/or semantic map data), among other examples. In turn, the scenario-type model may compare the respective likelihood for each predefined scenario type to a threshold (e.g., a minimum probability value of 75%), and then based on this comparison, may identify any predefined scenario type having a respective likelihood that satisfies the threshold as a scenario type that is likely being faced by the AV—which could result in an identification of no scenario type, one scenario type, or multiple different scenario types.

As another possibility, the scenario-type model may predict which of the predefined scenario types are likely being faced by the AV by performing functions similar to those described above, but if multiple different scenario types have respective likelihoods that satisfy the threshold, the scenario-type model may additionally filter these scenario types down to the one or more scenario types that are most likely being faced by the AV (e.g., the “top” one or more scenario types in terms of highest respective likelihood).

The manner in which the scenario-type model predicts which of the predefined scenario types are likely being faced by the AV at the given time may take other forms as well.

Further yet, the output of the scenario-type model may take various forms. For instance, as noted above, the output of the scenario-type model may comprise a value that indicates each scenario type identified as a result of the scenario-type model's prediction. In this respect, the value output by the scenario-type model may take any of forms discussed above (e.g., a textual descriptor, an alphanumeric code, or the like for each identified scenario type). Additionally, to the extent that the scenario-type model does not identify any scenario type that is likely being faced at the given time, the output of the scenario-type model could also comprise a value indicating that no scenario type has been identified (e.g., a “no scenario type” value or the like), although the scenario-type model could also be configured to output no value at all when no scenario type is identified.

Along with the value indicating each scenario type identified as a result of the scenario-type model's prediction, the output of the scenario-type model may comprise additional information as well. For example, in addition to outputting the value indicating each identified scenario type, the scenario-type model may also be configured to output a confidence level for each identified scenario type, which provides an indication of the scenario-type model's confidence that the identified scenario type is being faced by the AV. In this respect, a confidence level for an identified scenario type may be reflected in terms of the likelihood of the scenario type being faced by the AV, which may take the form of numerical metric (e.g., a probability value on a scale from 0 to 100 or 0.0 to 1.0) or a categorical metric (e.g., “High,” “Medium,” or “Low” confidence level), among other possibilities. As another example, in addition to outputting the value indicating each identified scenario type, the scenario-type model may also be configured to output an indication of whether the value of the scenario-type variable satisfies a threshold condition for evaluating whether the AV is facing any scenario type that presents an increased risk (e.g., a list of scenario types that have been categorized as presenting increased risk). The output of the scenario-type model may take other forms as well.

It should be understood that the scenario-type model used by on-board computing system 302 to obtain a value of the scenario-type variable may take various other forms as well. Further, while the scenario-type model is described above in terms of a single data science model, it should be understood that in practice, the scenario-type model may comprise a collection of multiple, individual data science models that each correspond to one predefined scenario type and are each configured to predict whether that one predefined scenario type is likely being faced by an AV. In this respect, the scenario-type model's overall output may be derived based on the outputs of the individual data science models.

Lastly, it should be understood that on-board computing system 302 may obtain data for the scenario-type variable in other manners as well.

Referring back to block 401 of FIG. 4, as another possibility, on-board computing system 302 could obtain data for a scenario variable that reflects a likelihood of AV 300′ making physical contact with another object in the AV's surrounding environment in the foreseeable future (e.g., within the next 5 seconds), which may be referred to herein as a “likelihood-of-contact variable.” In practice, the value of this likelihood-of-contact variable may comprise either a single “aggregated” value that reflects an overall likelihood of AV 300′ making physical contact with any object in the AV's surrounding environment in the foreseeable future or a vector of “individual” values that each reflect a respective likelihood of AV 300′ making physical contact with a different individual object in the AV's surrounding environment in the foreseeable future, among other possibilities. Further, in practice, the value of this likelihood-of-contact variable may comprise either a numerical value that reflects the likelihood of contact for AV 300′ (e.g., a probability value on a scale from 0 to 100 or 0.0 to 1.0) or a categorical value that reflects the likelihood of contact for AV 300′ (e.g., “High,” “Medium,” or “Low” likelihood), among other possibilities. The value of the likelihood-of-contact variable may take other forms as well.

On-board computing system 302 may obtain a value of the likelihood-of-contact variable for the current scenario faced by AV 300′ in various manners. In one implementation, on-board computing system 302 may obtain a value of the likelihood-of-contact variable for the current scenario faced by AV 300′ using a data science model that is configured to (i) receive input data that is potentially indicative of whether an AV may make physical contact with another object in the AV's surrounding environment during some future window of time (e.g., the next 5 seconds), (ii) based on an evaluation of the input data, predict a likelihood of the AV making physical contact with another object in the AV's surrounding environment during the future window of time, and (iii) output a value reflecting the predicted likelihood of the AV making physical contact with another object in the surrounding environment during the future window of time. This predictive model may be referred to herein as a “likelihood-of-contact model.”

In practice, such a likelihood-of-contact model will typically be created by an off-board computing system (e.g., a backend data processing system) and then loaded onto an AV's on-board computing system, although it is possible that a likelihood-of-contact model could be created by the AV's on-board computing system itself. Either way, the likelihood-of-contact model may be created using any modeling approach now known or later developed. For instance, as one possibility, the likelihood-of-contact model may be created by using one or more machine-learning techniques to “train” the likelihood-of-contact model to predict an AV's likelihood of contract based on training data. In this respect, the training data for the likelihood-of-contact model may take various forms. For instance, as one possibility, such training data may comprise one or both of (i) historical input data associated with past scenarios in which an AV is known to have had a very high likelihood of making physical contact with another object (e.g., scenarios where an AV nearly or actually made physical contact with another object) and/or (ii) historical input data associated with past scenarios in which an AV is known to have had little or no likelihood of making physical contact with another object. The training data for the likelihood-of-contact model may also take various other forms, including the possibility that the training data may include simulated input data instead of (or in addition to) historical input data. Likewise, the one or more machine-learning techniques used to train the likelihood-of-contact model may take any of various forms, including but not limited to any of the machine-learning techniques mentioned above.

However, it should be understood that a likelihood-of-contact model may be created in other manners as well, including the possibility that the likelihood-of-contact model may be coded by a data scientist (or the like) rather than being derived using a machine-learning technique. Likewise, it should be understood that the likelihood-of-contact model may also be updated periodically (e.g., based on newly-available historical input data).

The input data for the likelihood-of-contact model may take any of various forms. As one possibility, the input data for the likelihood-of-contact model may include certain types of raw data available to the AV, examples of which may include any of various types of sensor data captured by the AV (e.g., 2D sensor data, 3D sensor data, IMU/INS/GNSS data, etc.), map data associated with the AV's location (e.g., geometric and/or semantic map data), and/or other types of raw data that provides context for the AV's perception of its surrounding environment (e.g., weather data, traffic data, etc.), among other examples.

As another possibility, the input data for the likelihood-of-contact model may include certain types of derived data that is derived by an AV based on the types of raw data discussed above. For instance, in line with the discussion above, an AV may have an autonomy system that is configured to derive data indicating a class and current state of the objects detected in the AV's surrounding environment (e.g., a current position, current orientation, and current motion state of each such object), a predicted future state of the objects detected in the AV's surrounding environment (e.g., one or more future positions, future orientations, and future motion states of each such object), and/or a planned trajectory of the AV, among other examples, and at least some of this derived data may then serve as input data for the likelihood-of-contact model.

As yet another possibility, the input data for the likelihood-of-contact model may include data for other scenario variables characterizing the current scenario being faced by AV 300′, including but not limited to data for the scenario-type variable discussed above.

The input data for the likelihood-of-contact model may take other forms as well, including but not limited to the possibility that the input data for the likelihood-of-contact model may comprise some combination of the foregoing categories of data.

Further, the manner in which the likelihood-of-contact model predicts the likelihood of the AV making physical contact with another object in the AV's surrounding environment during a future window of time may take various forms. As one possibility, the likelihood-of-contact model may begin by predicting an individual likelihood that the AV will make physical contact with each of at least a subset of the objects detected in the AV's surrounding environment during a future window of time (e.g., a probability value on a scale from 0 to 100 or 0.0 to 1.0). In this respect, the likelihood-of-contact model's prediction of a likelihood that the AV will make physical contact with any individual object in the AV's surrounding environment during future window of time may be based on various features that may be included within (or otherwise be derived from) the input data, examples of which may include the type of object, the AV's current distance to the object, the predicted future state of the object during the future window of time, the planned trajectory of the AV during the future window of time, and/or the indication of which predefined scenario types are being faced by the AV, among other possibilities.

After predicting the respective likelihood of the AV making physical contact with each of various individual objects detected in the AV's surrounding environment, the likelihood-of-contact model may also be configured to aggregate these respective likelihoods into a single, aggregated likelihood of the AV making physical contact with any other object in the AV's surrounding environment during the future window of time. In this respect, the likelihood-of-contact model may aggregate the respective likelihoods using various aggregation techniques, examples of which may include taking a maximum of the respective likelihoods, taking a minimum of the respective likelihoods, or determining an average of the respective likelihoods (e.g., a mean, median, mode, or the like), among other possibilities.

The manner in which the likelihood-of-contact model predicts the likelihood of the AV making physical contact with another object in the AV's surrounding environment during a future window of time may take other forms as well.

Further yet, the output of the likelihood-of-contact model may take various forms. For instance, as noted above, the output of the likelihood-of-contact model may comprise a value that reflects the predicted likelihood of the AV making physical contact with another object in the surrounding environment during the future window of time, which may take any of the forms discussed above (e.g., it could be either an “aggregated” value or a vector of individual values, and could be either numerical or categorical in nature).

Along with the value reflecting the predicted likelihood of the AV making physical contact with another object in the surrounding environment during the future window of time, the output of the likelihood-of-contact model may comprise additional information as well. For example, in addition to outputting the value reflecting the predicted likelihood of the AV making physical contact with another object in the surrounding environment during the future window of time, the likelihood-of-contact model may also be configured to output an indication of whether the value satisfies a threshold condition for evaluating whether the likelihood of contact is deemed to present an increased risk (e.g., a probability of contact that is 50% or higher). As another example, in addition to outputting the value reflecting the predicted likelihood of the AV making physical contact with another object in the surrounding environment during the future window of time, the likelihood-of-contact model may also be configured to output an identification of one or more objects detected in the AV's surrounding environment that present the greatest risk of physical contact. In this respect, the identified one or more objects may comprise some specified number of the “top” objects in terms of likelihood of contact (e.g., the top one or two objects that present the highest likelihood of contact) or may comprise each object presenting a respective likelihood of contact that satisfies a threshold, among other possibilities. The output of the likelihood-of-contact model may take other forms as well.

It should be understood that the likelihood-of-contact model used by on-board computing system 302 to obtain a value of the likelihood-of-contact variable may take various other forms as well. Further, while the likelihood-of-contact model is described above in terms of a single data science model, it should be understood that in practice, the likelihood-of-contact model may comprise a collection of multiple different model instances that are each used to predict a likelihood of the AV making physical contact with a different individual object in the AV's surrounding environment. In this respect, the likelihood-of-contact model's overall output may be derived based on the outputs of these different model instances.

Lastly, it should be understood that on-board computing system 302 may obtain data for the likelihood-of-contact variable in other manners as well.

Referring again back to block 401 of FIG. 4, as yet another possibility, on-board computing system 302 could obtain data for a scenario variable that reflects an urgency level of the current scenario being faced by AV 300′, which may be referred to herein as an “urgency variable.” In practice, the value of this urgency variable may take various forms, examples of which may include a numerical value that reflects the urgency level of the current scenario being faced by AV 300′ (e.g., a value on a scale from 0 to 10) or a categorical metric that reflects the urgency level of the current scenario being faced by AV 300′ (e.g., “High,” “Medium,” or “Low” urgency), among other possibilities.

On-board computing system 302 may obtain a value of the urgency variable for the current scenario faced by AV 300′ in various manners. In one implementation, on-board computing system 302 may obtain a value of the urgency variable for the current scenario faced by AV 300′ using a data science model that is configured to (i) receive input data that is potentially indicative of the urgency level of a scenario being faced by an AV at a given time, (ii) based on an evaluation of the input data, predict an urgency level of the scenario being faced by the AV at the given time, and (iii) output a value that reflects the predicted urgency level. This predictive model may be referred to herein as an “urgency model.”

In practice, such an urgency model will typically be created by an off-board computing system (e.g., a backend data processing system) and then loaded onto an AV's on-board computing system, although it is possible that a urgency model could be created by the AV's on-board computing system itself. Either way, the urgency model may be created using any modeling approach now known or later developed. For instance, as one possibility, the urgency model may be created by using one or more machine-learning techniques to “train” the urgency model to predict an urgency level of the scenario being faced by an AV based on training data. In this respect, the training data for the urgency model may take various forms. For instance, as one possibility, such training data may comprise respective sets of historical input data associated with each of the different possible urgency levels that may be faced by an AV, such as a first historical dataset associated with scenarios in which an AV is known to have been facing a first urgency level, a second historical dataset associated with scenarios in which an AV is known to have been facing a second urgency level, and so on. The training data for the urgency model may take other forms as well, including the possibility that the training data may include simulated input data instead of (or in addition to) historical input data. Likewise, the one or more machine-learning techniques used to train the urgency model may take any of various forms, including but not limited to any of the machine-learning techniques mentioned above.

However, it should be understood that an urgency model may be created in other manners as well, including the possibility that the urgency model may be coded by a data scientist (or the like) rather than being derived using a machine-learning technique. Likewise, it should be understood that the urgency model may also be updated periodically (e.g., based on newly-available historical input data).

Further, the input data for the urgency model may take any of various forms. As one possibility, the input data for the urgency model may include certain types of raw data available to the AV, examples of which may include any of various types of sensor data captured by the AV (e.g., 2D sensor data, 3D sensor data, IMU/INS/GNSS data, etc.), map data associated with the AV's location (e.g., geometric and/or semantic map data), and/or other types of raw data that provides context for the AV's perception of its surrounding environment (e.g., weather data, traffic data, etc.), among other examples.

As another possibility, the input data for the urgency model may include certain types of derived data that is derived by an AV based on the types of raw data discussed above. For instance, in line with the discussion above, an AV may have an autonomy system that is configured to derive data indicating a class and current state of the objects detected in the AV's surrounding environment (e.g., a current position, current orientation, and current motion state of each such object), a predicted future state of the objects detected in the AV's surrounding environment (e.g., one or more future positions, future orientations, and future motion states of each such object), and/or a planned trajectory of the AV, among other examples, and at least some of this derived data may then serve as input data for the urgency model.

As yet another possibility, the input data for the urgency model may include data for other scenario variables characterizing the current scenario being faced by AV 300′, including but not limited to data for the scenario-type and/or likelihood-of-contact variables discussed above.

The input data for the urgency model may take other forms as well, including but not limited to the possibility that the input data for the urgency model may comprise some combination of the foregoing categories of data.

Further, the manner in which the urgency model predicts the urgency level of the scenario being faced by the AV at the given time may take various forms. As one possibility, the urgency model may predict such an urgency level based on features such as the AV's current distance to the object detected in the surrounding environment, the AV's current motion state (e.g., speed, acceleration, etc.), the planned trajectory of the AV, the current and/or predicted future state of the objects detected in the surrounding environment, and/or the AV's likelihood of contact. However, the manner in which the urgency model predicts the urgency level of the scenario being faced by the AV at the given time could take other forms as well.

Further yet, the output of the urgency model may take various forms. For instance, as noted above, the output of the urgency model may comprise a value that reflects the predicted urgency level of the scenario being faced by the AV, which may take any of the forms discussed above (e.g., a value that is either numerical or categorical in nature).

Along with the value reflecting the predicted urgency level of the scenario being faced by the AV, the output of the urgency model may comprise additional information as well. For example, in addition to outputting the value reflecting the predicted urgency level of the scenario being faced by the AV, the urgency model may also be configured to output an indication of whether the value satisfies a threshold condition for evaluating whether the urgency level is deemed to present an increased risk (e.g., an urgency level of 5 or higher). As another example, in addition to outputting the value reflecting the urgency level of the scenario being faced by the AV, the urgency model may also be configured to output an identification of one or more “driving factors” for the urgency level. The urgency model's output may take other forms as well.

It should be understood that the urgency model used by on-board computing system 302 to obtain a value of the urgency variable may take various other forms as well.

Lastly, it should be understood that on-board computing system 302 may obtain data for the urgency variable in other manners as well.

Referring once more back to block 401 of FIG. 4, as still another possibility, on-board computing system 302 could obtain data for a scenario variable that reflects a likelihood that the safety driver of AV 300′ will decide to switch AV 300′ from autonomous mode to manual mode in the foreseeable future (e.g., within the next 5 seconds), which may be referred to herein as a “likelihood-of-disengagement variable.” In practice, the value of the likelihood-of-disengagement variable may take various forms, examples of which may include a numerical value that reflects a current likelihood of disengagement for AV 300′ (e.g., a probability value on a scale from 0 to 100 or 0.0 to 1.0) or a categorical value that reflects a current likelihood of disengagement for AV 300′ (e.g., “High,” “Medium,” or “Low” likelihood), among other possibilities.

On-board computing system 302 may obtain a value of the likelihood-of-disengagement variable associated with the current scenario faced by AV 300′ in various manners. In one implementation, on-board computing system 302 may obtain a value of the likelihood-of-disengagement variable associated with the current scenario faced by AV 300′ using a data science model that is configured to (i) receive input data that is potentially indicative of whether a safety driver of an AV may decide switch the AV from autonomous mode to manual mode during some future window of time (e.g., the next 5 seconds), (ii) based on an evaluation of the input data, predict a likelihood that the safety driver of the AV will decide to switch the AV from autonomous mode to manual mode during the future window of time, and (iii) output a value that reflects the predicted likelihood that the safety driver will decide to switch the AV from autonomous mode to manual mode during the future window of time. This predictive model may be referred to herein as a “likelihood-of-disengagement model.”

In practice, such a likelihood-of-disengagement model will typically be created by an off-board computing system (e.g., a backend data processing system) and then loaded onto an AV's on-board computing system, although it is possible that a likelihood-of-disengagement model could be created by the AV's on-board computing system itself. Either way, the likelihood-of-disengagement model may be created using any modeling approach now known or later developed. For instance, as one possibility, the likelihood-of-contact model may be created by using one or more machine-learning techniques to “train” the likelihood-of-disengagement model to predict a likelihood that the safety driver of the AV will decide to switch the AV from autonomous mode to manual mode during the future window of time based on training data. In this respect, the training data for the likelihood-of-disengagement model may take various forms. For instance, as one possibility, such training data may comprise one or both of (i) historical input data associated with past scenarios in which a safety driver actually decided to disengage at the time and/or (ii) historical input data associated with past scenarios that have been evaluated by a qualified individual (e.g., safety driver, safety engineer, or the like) and deemed to present an appropriate scenario for disengagement, regardless of whether the safety driver actually decided to disengage at the time. Advantageously, training data such as this may leverage the knowledge and experience of individuals that have historically been involved in making disengagement decisions. The training data for the likelihood-of-disengagement model may take other forms as well, including the possibility that the training data may include simulated input data instead of (or in addition to) historical input data. Likewise, the one or more machine-learning techniques used to train the likelihood-of-disengagement model may take any of various forms, including but not limited to any of the machine-learning techniques mentioned above.

However, it should be understood that a likelihood-of-disengagement model may be created in other manners as well, including the possibility that the likelihood-of-disengagement model may be coded by a data scientist (or the like) rather than being derived using a machine-learning technique. Likewise, it should be understood that the likelihood-of-disengagement model may also be updated periodically (e.g., based on newly-available historical input data).

Further, the input data for the likelihood-of-disengagement model may take any of various forms. As one possibility, the input data for the likelihood-of-disengagement model may include certain types of raw data available to the AV, examples of which may include any of various types of sensor data captured by the AV (e.g., 2D sensor data, 3D sensor data, IMU/INS/GNSS data, etc.), map data associated with the AV's location (e.g., geometric and/or semantic map data), and/or other types of raw data that provides context for the AV's perception of its surrounding environment (e.g., weather data, traffic data, etc.), among other examples.

As another possibility, the input data for the likelihood-of-disengagement model may include certain types of derived data that is derived by an AV based on the types of raw data discussed above. For instance, in line with the discussion above, an AV may have an autonomy system that is configured to derive data indicating a class and current state of the objects detected in the AV's surrounding environment (e.g., current position, current orientation, and current motion state of each such object), a predicted future state of the objects detected in the AV's surrounding environment (e.g., one or more future positions, future orientations, and future motion states of each such object), and/or a planned trajectory of the AV, among other examples, and at least some of this derived data may then serve as input data for the likelihood-of-disengagement model.

As yet another possibility, the input data for the likelihood-of-disengagement model may include data for other scenario variables characterizing the current scenario being faced by AV 300′, including but not limited to data for the scenario-type, likelihood-of-contact, and/or urgency variables discussed above.

The input data for the likelihood-of-disengagement model may take other forms as well, including but not limited to the possibility that the input data for the likelihood-of-disengagement model may comprise some combination of the foregoing categories of data.

Further, the manner in which the likelihood-of-disengagement model predicts the likelihood that the safety driver of the AV will decide to switch the AV from autonomous mode to manual mode during the future window of time may take various forms. As one possibility, the likelihood-of-disengagement model may predict such a likelihood based on features such as the types of objects detected in the surrounding environment, the current and/or predicted future state of the objects detected in the surrounding environment, the planned trajectory of the AV during the future window of time, and the indication of which predefined scenario types are currently being faced by the AV, among other examples. However, the manner in which the likelihood-of-disengagement model predicts the likelihood that the safety driver of the AV will decide to switch the AV from autonomous mode to manual mode during the future window of time could take other forms as well, including the possibility that the likelihood-of-disengagement model could also make adjustments to the predicted likelihood based on other factors (e.g., the value that reflects the likelihood of contact and/or the value that reflects the urgency level).

Further yet, the output of the likelihood-of-disengagement model may take various forms. For instance, as noted above, the output of the likelihood-of-disengagement model may comprise a value that reflects the predicted likelihood that the safety driver will decide to switch the AV from autonomous mode to manual mode during the future window of time, which may take any of the forms discussed above (e.g., a value that is either numerical or categorical in nature).

Along with the value that reflects the predicted likelihood that the safety driver will decide to switch the AV from autonomous mode to manual mode during the future window of time, the output of the likelihood-of-disengagement model may comprise additional information as well. For example, in addition to outputting the value that reflects the predicted likelihood that the safety driver will decide to switch the AV from autonomous mode to manual mode during the future window of time, the likelihood-of-disengagement model may also be configured to output an indication of whether the value satisfies a threshold condition for evaluating whether the likelihood of disengagement is deemed to present an increased risk (e.g., a probability of disengagement that is 50% or higher). As another example, in addition to outputting the value that reflects the predicted likelihood that the safety driver of the AV will decide to switch the AV from autonomous mode to manual mode during the future window of time, the likelihood-of-disengagement model may also be configured to output an identification of one or more “driving factors” that are most impactful to the safety driver's decision as to whether to switch the AV from autonomous mode to manual mode during the future window of time. The output of the likelihood-of-disengagement model may take other forms as well.

It should be understood that the likelihood-of-disengagement model used by on-board computing system to obtain a value of the likelihood-of-disengagement variable may take various other forms as well.

Lastly, it should be understood that on-board computing system 302 may obtain data for the likelihood-of-disengagement in other manners as well.

While the foregoing has set forth certain examples of scenario variables that may be used to characterize the current scenario being faced by AV 300′, it should be understood that the scenario variables characterizing the current scenario being faced by AV 300′ may take other forms as well. Further, it should be understood that, in some embodiments, on-board computing system 302 may further be configured to combine the values for some or all of the scenario variables into a composite value (or “score”) that reflects an overall risk level of the current scenario being faced by AV 300′.

Turning now to block 402 of FIG. 4, on-board computing system 302 may use the obtained data for the one or more scenario variables characterizing the current scenario being faced by AV 300′ as a basis for determining whether the current scenario warrants presentation of any scenario-based information to a safety driver of AV 300′. On-board computing system 302 may make this determination in various manners.

In one implementation, on-board computing system 302 may determining whether the current scenario warrants presentation of scenario-based information to the safety driver of AV 300′ by evaluating whether the obtained data for the one or more scenario variables satisfies certain threshold criteria, which may take any of various forms.

For instance, the threshold criteria could comprise a threshold condition for one single scenario variable that characterizes the current scenario being faced by AV 300′, in which case on-board computing system 302 may determine that the current scenario warrants presentation of scenario-based information to the safety driver of AV 300′ if this one threshold condition is met.

Alternatively, the threshold criteria could comprise a string of threshold conditions for multiple scenario variables that are connected by Boolean operators. For example, the threshold criteria may comprise a string of threshold conditions for multiple different scenario variables that are all connected by “AND” operators, in which case on-board computing system 302 may only determine that the current scenario warrants presentation of scenario-based information to the safety driver of AV 300′ if all of the threshold conditions are met. As another example, the threshold criteria may comprise a string of threshold conditions for multiple different scenario variables that are all connected by “OR” operators, in which case on-board computing system 302 may determine that the current scenario warrants presentation of scenario-based information to the safety driver of AV 300′ if any one of the threshold conditions are met. Other examples are possible as well, including the possibility that the threshold conditions in a string are connected by a mix of “AND” and “OR” operators.

Further, each threshold condition included as part of the threshold criteria may take any of various forms, which may depend at least in part on which data variable is to be evaluated using the threshold condition. For example, a threshold condition for the scenario-type variable may comprise a list of scenario types that have been categorized as presenting increased risk, in which case the threshold condition is satisfied if the obtained value of the scenario-type value matches any of the scenario types on the list. As another example, a threshold condition for the likelihood-of-contact variable, the urgency variable, and/or the likelihood-of-disengagement variable may comprise a threshold value at which the data variable's value is deemed to present an increased risk, in which case the threshold condition is satisfied if the obtained value of the data variable has reached this threshold value. A threshold condition for a scenario variable that characterizes the current scenario being faced by AV 300′ may take other forms as well.

Further yet, in some embodiments, on-board computing system 302 may be configured to use different threshold criteria in different circumstances (as opposed to using the same threshold criteria in all circumstances). For instance, as one possibility, on-board computing system 302 may be configured to use different threshold criteria depending on which of the predefined scenario types are currently being faced by AV 300′, in which case on-board computing system 302 may use the obtained value of the scenario-type variable as a basis for selecting threshold criteria that is then used to evaluate one or more other scenario variables characterizing the current scenario being faced by AV 300′ (e.g., the likelihood-of-contact, urgency, and/or likelihood-of-disengagement variables). One example of this functionality may involve using a lower threshold to evaluate the obtained data for one of the other scenario variables that characterize the current scenario being faced by AV 300′ when the obtained value of the scenario-type variable reflects that AV 300′ is facing at least one scenario type that is considered to present increased risk (which may make it more likely that on-board computing system 302 will decide to present scenario-based information to the safety driver) and otherwise using a higher threshold to evaluate the obtained value of that data variable. The threshold criteria used by on-board computing system 302 to evaluate the one or more scenario variables characterizing the current scenario being faced by AV 300′ could be dependent on other factors as well.

On-board computing system 302 may make the determination of whether the current scenario warrants presentation of scenario-based information to the safety driver of AV 300′ in other manners as well. For instance, as discussed above, the data science models for the scenario variables could output indicators of whether the data for such data variables satisfies certain threshold conditions, in which case on-board computing system 302 could determine whether the current scenario warrants presentation of scenario-based information to the safety driver of AV 300′ based on these indicators output by the data science models. Alternatively, as discussed above, on-board computing system 302 could be configured to combine the values for some or all of the scenario variables into a composite value (or “score”) that reflects an overall risk level of the current scenario being faced by AV 300′, in which case on-board computing system 302 could determine whether the current scenario warrants presentation of scenario-based information to the safety driver of AV 300′ by evaluating whether this composite value satisfies a threshold condition. Other implementations are possible as well.

If on-board computing system 302 determines that the current scenario does not warrant presentation of any scenario-based information to the safety driver of AV 300′ at block 402, then on-board computing system 302 may terminate the example process illustrated in FIG. 4. On the other hand, if on-board computing system 302 determines that the current scenario does warrant presentation of scenario-based information to the safety driver of AV 300′ at block 402, then on-board computing system 302 may proceed to blocks 403-404 of the example process illustrated in FIG. 4.

At block 403, in response to determining that the current scenario warrants presentation of scenario-based information to the safety driver of AV 300′, on-board computing system 302 may select a particular set of scenario-based information (e.g., visual and/or audio information) to present to the safety driver of AV 300′. The information that is selected for inclusion in this set of scenario-based information may take various forms.

As one possibility, the selected set of scenario-based information may include information about one or more dynamic objects detected in the AV's surrounding environment, such as vehicles, cyclists, or pedestrians. In this respect, the selected information about a dynamic object may take various forms. For example, the selected information about a dynamic object may include a bounding box reflecting the AV's detection of the dynamic object, which is to be presented visually via HUD system 304a in a manner that makes it appear to the safety driver as though the bounding box is superimposed onto the dynamic object itself. As another example, the selected information about a dynamic object may include a recognized class of the dynamic object, which is to be presented visually via HUD system 304a and could take the form of text or coloring that is associated with the dynamic object's bounding box. As yet another example, the selected information about a dynamic object may include a future trajectory of the dynamic object as predicted by AV 300′, which is to be presented visually via HUD system 304a and could take the form of (i) a path that begins at the spot on the AV's windshield where the dynamic object appears to the safety driver and extends in the direction that the dynamic object is predicted to move and/or (ii) an arrow that is positioned on the AV's windshield at the spot where the dynamic object appears to the safety driver and points in the direction that the dynamic object is predicted to move, among other possible forms. At still another example, the selected information about a dynamic object may include the AV's likelihood of making physical contact with the dynamic object, which is to be presented either visually via HUD system 304a or audibly via speaker system 304b. The selected information for a dynamic object may take other forms as well.

As another possibility, the selected set of scenario-based information may include information about one or more static objects detected in the AV's surrounding environment, such as traffic lights or stop signs. In this respect, the selected information about a static object may take various forms. For example, the selected information about a static object may include a bounding box reflecting the AV's detection of the static object, which is to be presented visually via HUD system 304a in a manner that makes it appear to the safety driver as though the bounding box is superimposed onto the static object itself. As another example, the selected information about a static object may include a recognized class of the static object, which is to be presented visually via HUD system 304a and could take the form of text, coloring, or the like that is associated with the static object's bounding box. As yet another example, to the extent that AV 300′ detects a traffic light, the selected information about the traffic light may include a perceived and/or predicted state of the traffic light (e.g., green, yellow, or red), which could take the form of visual information to be presented visually via HUD system 304a in the form of text, coloring, or the like that is positioned at or near the spot on the AV's windshield where the traffic light appears (perhaps in conjunction with a bounding box) and/or audio information to be presented audibly via speaker system 304b (e.g., “Traffic light is green/yellow/red”). At still another example, the selected information about a static object may include the AV's likelihood of making physical contact with the static object, which is to be presented either visually via HUD system 304a or audibly via speaker system 304b. The selected information for a static object may take other forms as well.

As yet another possibility, the selected set of scenario-based information may include information about AV 300′ itself, which may take various forms. For example, the selected information about AV 300′ may include the AV's planned trajectory, which is to be presented visually via HUD system 304a in a manner that makes it appear to the safety driver as though the trajectory is superimposed onto the real-world environment that can be seen through the AV's windshield. As another example, to the extent that the AV's planned behavior additionally includes a “stop fence” associated with a stop sign, a traffic light, or lead vehicle, the selected information about AV 300′ may include this stop fence, which is to be presented visually via HUD system 304a and could take the form of a semitransparent wall or barrier that appears to the safety driver as though it is superimposed onto the real-world environment at the location where AV 300′ plans to stop (perhaps along with some visible indication of how long AV 300′ plans to stop when it reaches the stop fence). As yet another example, the selected information about AV 300′ may include the operating health of certain systems and/or components of the AV (e.g., the AV's autonomy system), which is to be presented either visually via HUD system 304a or audibly via speaker system 304b. The selected information for AV 300′ may take other forms as well.

As still another possibility, the selected set of scenario-based information may include information characterizing the current scenario being faced by AV 300′. For example, the selected information characterizing the current scenario being faced by AV 300′ could include the one or more scenario-types being faced by AV 300′, the likelihood of contact presented by the current scenario being faced by AV 300′, the urgency level of the current scenario being faced by AV 300′, and/or the likelihood of disengagement presented by the current scenario being faced by AV 300′, which is to be presented either visually via HUD system 304a (e.g., in the form of a textual or graphical indicator) or audibly via speaker system 304b.

The information that may be selected for inclusion in the set of scenario-based information may take various other forms as well.

Further, the function of selecting the set of scenario-based information to present to the safety driver of AV 300′ may take various forms. In one implementation, on-board computing system 302 may be configured to present the same “default” pieces of scenario-based information to the safety driver of AV 300′ each time it makes a determination that the current scenario warrants presentation of scenario-based information to the safety driver of AV 300′ regardless of the specific nature of the current scenario being faced by AV 300′, in which case the function of selecting the set of scenario-based information to present to the safety driver of AV 300′ may involve selecting these default pieces of scenario-based information. For example, on-board computing system 302 may be configured such that, any time it makes a determination that the current scenario warrants presentation of scenario-based information to the safety driver of AV 300′, on-board computing system 302 selects a “default” set of scenario-based information that includes bounding boxes and predicted future trajectories for a specified number of dynamic objects that are in closest proximity to AV 300′ (e.g., the one, two, or three closest dynamic objects). Such a “default” set of scenario-based information may take various other forms as well.

In another implementation, on-board computing system 302 may be configured to present different pieces of scenario-based information to the safety driver of AV 300′ depending on the specific nature of the current scenario being faced by AV 300′. In such an implementation, the function of selecting the set of scenario-based information to present to the safety driver of AV 300′ may involve selecting which particular pieces of information to include in the set of scenario-based information to be presented to the safety driver based on certain data that characterizes the current scenario being faced by AV 300′, including but not limited to the obtained data for the one or more scenario variables discussed above.

For instance, as one possibility, on-board computing system 302 may be configured to use the obtained value of the scenario-type variable as a basis for selecting which scenario-based information to present to the safety driver, in which case the safety driver could be presented with different kinds of scenario-based information depending on which predefined scenario types are being faced by AV 300′. To illustrate with an example, on-board computing system 302 could be configured such that (i) if AV 300′ is facing an “approaching a traffic-light intersection” or “approaching a stop-sign intersection” scenario, on-board computing system 302 may select information about the traffic light or stop sign object (e.g., a bounding box and a traffic light status), information about the AV's stop fence for the intersection, and information about every dynamic object that is involved in the “approaching a traffic-light intersection” or “approaching a stop-sign intersection” scenario (e.g., bounding boxes and predicted future trajectories), whereas (ii) if AV 300′ is facing some other scenario type (or no scenario type at all), on-board computing system 302 may not select any information for static objects or any stop fences, and may only select information for a specified number of dynamic objects that are in closest proximity to AV 300′ (e.g., the one, two, or three closest dynamic objects). The manner in which the set of scenario-based information may vary based on scenario type may take various other forms as well.

As yet another possibility, on-board computing system 302 may be configured to use the obtained value of the likelihood-of-contact variable, the urgency variable, or likelihood-of-disengagement variable as a basis for selecting different “levels” of scenario-based information that are associated with different risk levels. To illustrate with an example, on-board computing system 302 could be configured such that (i) if the obtained value of the likelihood-of-contact variable, the urgency variable, or likelihood-of-disengagement variable is within one range that is deemed to present lower level of risk, on-board computing system 302 may select one set of scenario-based information that includes less detail about the current scenario being faced by AV 300′, whereas (ii) if the obtained value of the likelihood-of-contact variable, the urgency variable, or likelihood-of-disengagement variable is within another range that is deemed to present a higher level of risk, on-board computing system 302 may select a different set of scenario-based information that includes more detail about the current scenario being faced by AV 300′. The manner in which the set of scenario-based information may vary based on scenario type may take various other forms as well.

In line with the discussion above, it should also be understood that on-board computing system 302 may use certain information about the objects detected in the AV's surrounding environment as a basis for selecting which scenario-based information to present to the safety driver. For instance, in some cases, on-board computing system 302 may use recognized classes of the objects detected in the AV's surrounding environment as a basis for selecting which scenario-based information to present to the safety driver (e.g., by including information for dynamic objects but perhaps not static objects). In other cases, on-board computing system 302 may use the AV's distance to the objects detected in the AV's surrounding environment as a basis for selecting which scenario-based information to present to the safety driver (e.g., by including information for a specified number of the “closest” dynamic objects). In still other cases, on-board computing system 302 may use the AV's respective likelihood of making physical contact with each of various objects detected in the AV's surrounding environment as a basis for selecting which scenario-based information to present to the safety driver (e.g., by including information for a specified number of the “top” dynamic objects in terms of likelihood of contact or information for each dynamic object presenting a respective likelihood of contact that satisfies a threshold). It is possible that on-board computing system 302 may consult other information about the objects detected in the AV's surrounding environment as well.

The information that is included within the set of scenario-based information to be presented to the safety driver of AV 300′ may take various other forms and be selected in various other manners as well.

At block 404, on-board computing system 302 may then present the selected set of scenario-based information to the safety driver of AV 300′ via driver-presentation system 304 (e.g., by instructing HUD system 304a or speaker system 304b to output the information). As discussed above, the form of this scenario-based information and the manner in which it is presented may take various different forms.

For instance, in line with the discussion above, the selected set of scenario-based information may include various information that is to be presented visually via HUD system 304a, in which case on-board computing system 302 may present such information via HUD system 304a (e.g., by instructing via HUD system 304a to output the information). This presentation via HUD system 304a may take various forms, examples of which may include visual representations of bounding boxes for certain objects detected in the AV's surrounding environment, visual indications of the recognized classes of certain objects detected in the AV's surrounding environment, visual representations of the predicted future trajectories of certain dynamic objects detected in the AV's surrounding environment, visual indications of the AV's likelihood of making physical contact with certain objects, a visual representation of the AV's planned trajectory and/or other aspects of the AV's planned behavior (e.g., stop fences), a visual indication of the operating health of certain systems and/or components of the AV, and/or a visual indication of other information characterizing the current scenario being faced by AV 300′, among other possibilities.

Further, in line with the discussion above, the selected set of scenario-based information could also include certain information that is to be presented audibly via speaker system 304b, in which case on-board computing system 302 may present such information via speaker system 304b (e.g., by instructing speaker system 304b to output the information). This presentation via speaker system 304b may take various forms, examples of which may include audible indications of the AV's likelihood of making physical contact with certain objects, the operating health of certain systems and/or components of the AV, and/or other information characterizing the current scenario being faced by AV 300′, among other possibilities.

In some embodiments, on-board computing system 302 may also be configured to present certain pieces of the scenario-based information using some form of emphasis. In this respect, the function of presenting a piece of scenario-based information using emphasis may take various different forms, which may depend in part on the piece of scenario-based information being emphasized. For example, in the context of information to be presented visually via HUD system 304a, the function of presenting a piece of scenario-based information using emphasis may take the form of presenting the piece of scenario-based information using a different color and/or font than other information presented via HUD system 304a, presenting the piece of scenario-based information in a flashing or blinking manner, and/or presenting the piece of scenario-based information together with an additional indicator that draws the safety driver's attention to that information (e.g., a box, arrow, or the like), among other possibilities. As another example, in the context of information to be presented audibly via speaker system 304b, the function of presenting a piece of scenario-based information using emphasis may take the form of presenting the piece of scenario-based information using voice output that has a different volume or tone than the voice output used for the other information presented via speaker system 304b, among other possibilities. The function of presenting a piece of scenario-based information using emphasis may take other forms as well.

Further, on-board computing system 302 may determine whether to present pieces of the scenario-based information using emphasis based on various factors, examples of which may include the type of scenario-based information to be presented to the safety driver, the scenario type(s) being faced by AV 300′, the likelihood of contact presented by the current scenario being faced by AV 300′, the urgency level of the current scenario being faced by AV 300′, and/or the likelihood of disengagement presented by the current scenario being faced by AV 300′, among various other possibilities.

The function presenting the selected set of scenario-based information to the safety driver of AV 300′ may take various other forms as well, including the possibility that on-board computing system 302 could be configured to present such information to the safety driver of AV 300′ via an output system other than HUD system 304a or speaker system 304b. For example, instead of (or in addition to) presenting visual information via HUD system 304a, on-board computing system 302 could be configured to present certain visual information via a display screen included as part of the AV's control console and/or a remote display screen, in which case such information could be shown relative to a computer-generated representation of the AV's surrounding environment as opposed to the real-world environment itself. Other examples are possible as well.

Some possible examples of how the foregoing process may be used to intelligently present autonomy-system-based information for an AV to an individual tasked with overseeing the AV's operation within its surrounding environment were previously illustrated and discussed above with reference to FIGS. 2A-D. For instance, as discussed above, FIG. 2B illustrates one example where an AV having the disclosed technology may determine that the current scenario being faced by the AV warrants presentation of one set of scenario-based information that includes a bounding box and a predicted trajectory for a moving vehicle that is detected to be in close proximity to the AV, and FIGS. 2C-D illustrate another example where an AV having the disclosed technology may determine that the current scenario being faced by the AV warrants presentation of another set of scenario-based information that includes a bounding box for a stop sign at an intersection, bounding boxes and predicted future trajectories for a vehicle and pedestrian detected at the intersection, a stop wall that indicates where the AV plans to stop for the stop sign, an a audio notification that AV 200 has detected an “approaching a stop-sign intersection” type of scenario.

In this way, the disclosed technology may advantageously enable a safety driver (or the like) to monitor the status of the AV's autonomy system—which may help the safety driver of the AV make a timely and accurate decision as to whether to switch the AV from an autonomous mode to a manual mode—while at the same time minimizing the risk of overwhelming and/or distracting the safety driver with extraneous information that is not particularly relevant to the safety driver's task.

After on-board computing system 302 presents the selected set of scenario-based information to the safety driver of AV 300′ at block 404, the current iteration of the example process illustrated in FIG. 4 may be deemed completed. Thereafter, on-board computing system 302 may continue presenting the selected set of scenario-based information while on-board computing system 302 also periodically repeats the example process illustrated in FIG. 4 to evaluate whether the scenario-based information being presented to the safety driver should be changed. In this respect, as one possibility, a subsequent iteration of the example process illustrated in FIG. 4 may result in on-board computing system 302 determining that the current scenario being faced by AV 300′ no longer warrants presenting any scenario-based information to the safety driver of AV 300′, in which case on-board computing system 302 may stop presenting any scenario-based information to the safety driver. As another possibility, a subsequent iteration of the example process illustrated in FIG. 4 may result in on-board computing system 302 determining that the current scenario being faced by AV 300′ warrants presentation of a different set of scenario-based information to the safety driver of AV 300′, in which case on-board computing system 302 may update the presentation of the scenario-based information to the safety driver to reflect the different set of scenario-based information.

On-board computing system 302 may be configured to change the scenario-based information being presented to the safety driver of AV 300′ in response to other triggering events as well. For instance, as one possibility, on-board computing system 302 may be configured to stop presenting any scenario-based information to the safety driver in response to detecting that the safety driver has switched AV 300′ from autonomous mode to manual mode. As another possibility, on-board computing system 302 may be configured to stop presenting any scenario-based information to the safety driver in response to a request from the safety driver, which the safety driver may communicate to on-board computing system 302 by pressing a button on the AV's control console or speaking out a verbal request that can be detected by the AV's microphone, among other possibilities.

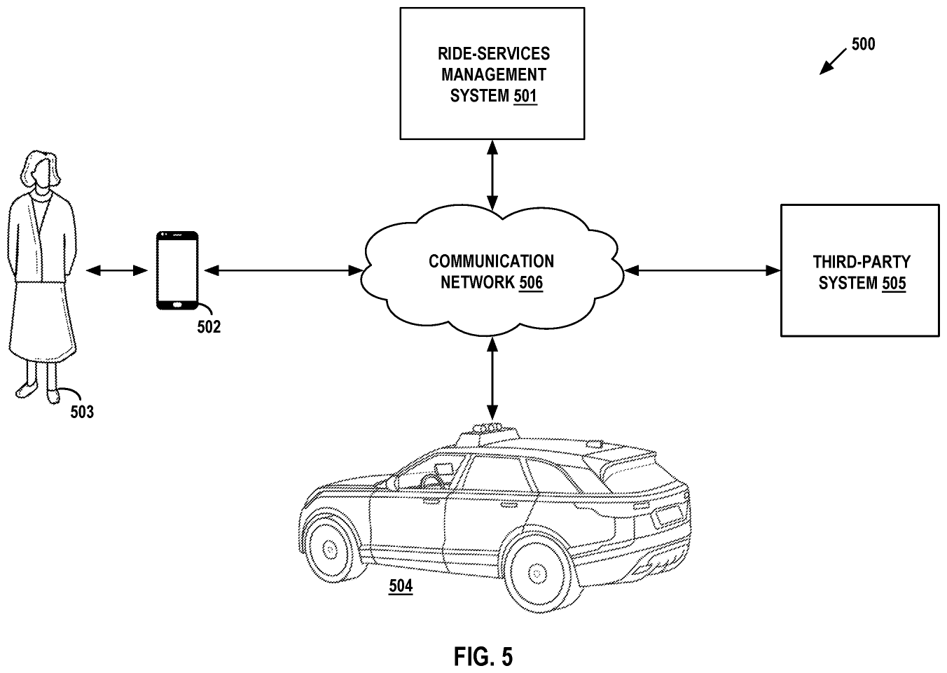

The are many use cases for the AVs described herein, including but not limited to use cases for transportation of both human passengers and various types of goods. In this respect, one possible use case for the AVs described herein involves a ride-services platform in which individuals interested in taking a ride from one location to another are matched with vehicles (e.g., AVs) that can provide the requested ride. FIG. 5 is a simplified block diagram that illustrates one example of such a ride-services platform 500. As shown, ride-services platform 500 may include at its core a ride-services management system 501, which may be communicatively coupled via a communication network 506 to (i) a plurality of client stations of individuals interested in taking rides (i.e., “ride requestors”), of which client station 502 of ride requestor 503 is shown as one representative example, (ii) a plurality of AVs that are capable of providing the requested rides, of which AV 504 is shown as one representative example, and (iii) a plurality of third-party systems that are capable of providing respective subservices that facilitate the platform's ride services, of which third-party system 505 is shown as one representative example.

Broadly speaking, ride-services management system 501 may include one or more computing systems that collectively comprise a communication interface, at least one processor, data storage, and executable program instructions for carrying out functions related to managing and facilitating ride services. These one or more computing systems may take various forms and be arranged in various manners. For instance, as one possibility, ride-services management system 501 may comprise computing infrastructure of a public, private, and/or hybrid cloud (e.g., computing and/or storage clusters). In this respect, the entity that owns and operates ride-services management system 501 may either supply its own cloud infrastructure or may obtain the cloud infrastructure from a third-party provider of “on demand” computing resources, such as Amazon Web Services (AWS), Microsoft Azure, Google Cloud, Alibaba Cloud, or the like. As another possibility, ride-services management system 501 may comprise one or more dedicated servers. Other implementations of ride-services management system 501 are possible as well.

As noted, ride-services management system 501 may be configured to perform functions related to managing and facilitating ride services, which may take various forms. For instance, as one possibility, ride-services management system 501 may be configured to receive ride requests from client stations of ride requestors (e.g., client station 502 of ride requestor 503) and then fulfill such ride requests by dispatching suitable vehicles, which may include AVs such as AV 504. In this respect, a ride request from client station 502 of ride requestor 503 may include various types of information.

For example, a ride request from client station 502 of ride requestor 503 may include specified pick-up and drop-off locations for the ride. As another example, a ride request from client station 502 of ride requestor 503 may include an identifier that identifies ride requestor 503 in ride-services management system 501, which may be used by ride-services management system 501 to access information about ride requestor 503 (e.g., profile information) that is stored in one or more data stores of ride-services management system 501 (e.g., a relational database system), in accordance with the ride requestor's privacy settings. This ride requestor information may take various forms, examples of which include profile information about ride requestor 503. As yet another example, a ride request from client station 502 of ride requestor 503 may include preferences information for ride requestor 503, examples of which may include vehicle-operation preferences (e.g., safety comfort level, preferred speed, rates of acceleration or deceleration, safety distance from other vehicles when traveling at various speeds, route, etc.), entertainment preferences (e.g., preferred music genre or playlist, audio volume, display brightness, etc.), temperature preferences, and/or any other suitable information.

As another possibility, ride-services management system 501 may be configured to access ride information related to a requested ride, examples of which may include information about locations related to the ride, traffic data, route options, optimal pick-up or drop-off locations for the ride, and/or any other suitable information associated with a ride. As an example and not by way of limitation, when ride-services management system 501 receives a request to ride from San Francisco International Airport (SFO) to Palo Alto, Calif., system 501 may access or generate any relevant ride information for this particular ride request, which may include preferred pick-up locations at SFO, alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason, one or more routes to travel from SFO to Palo Alto, preferred off-ramps for a type of ride requestor, and/or any other suitable information associated with the ride.

In some embodiments, portions of the accessed ride information could also be based on historical data associated with historical rides facilitated by ride-services management system 501. For example, historical data may include aggregate information generated based on past ride information, which may include any ride information described herein and/or other data collected by sensors affixed to or otherwise located within vehicles (including sensors of other computing devices that are located in the vehicles such as client stations). Such historical data may be associated with a particular ride requestor (e.g., the particular ride requestor's preferences, common routes, etc.), a category/class of ride requestors (e.g., based on demographics), and/or all ride requestors of ride-services management system 501.

For example, historical data specific to a single ride requestor may include information about past rides that a particular ride requestor has taken, including the locations at which the ride requestor is picked up and dropped off, music the ride requestor likes to listen to, traffic information associated with the rides, time of day the ride requestor most often rides, and any other suitable information specific to the ride requestor. As another example, historical data associated with a category/class of ride requestors may include common or popular ride preferences of ride requestors in that category/class, such as teenagers preferring pop music, ride requestors who frequently commute to the financial district may prefer to listen to the news, etc. As yet another example, historical data associated with all ride requestors may include general usage trends, such as traffic and ride patterns.

Using such historical data, ride-services management system 501 could be configured to predict and provide ride suggestions in response to a ride request. For instance, ride-services management system 501 may be configured to apply one or more machine-learning techniques to such historical data in order to “train” a machine-learning model to predict ride suggestions for a ride request. In this respect, the one or more machine-learning techniques used to train such a machine-learning model may take any of various forms, examples of which may include a regression technique, a neural-network technique, a kNN technique, a decision-tree technique, a SVM technique, a Bayesian technique, an ensemble technique, a clustering technique, an association-rule-learning technique, and/or a dimensionality-reduction technique, among other possibilities.

In operation, ride-services management system 501 may only be capable of storing and later accessing historical data for a given ride requestor if the given ride requestor previously decided to “opt-in” to having such information stored. In this respect, ride-services management system 501 may maintain respective privacy settings for each ride requestor that uses ride-services platform 500 and operate in accordance with these settings. For instance, if a given ride requestor did not opt-in to having his or her information stored, then ride-services management system 501 may forgo performing any of the above-mentioned functions based on historical data. Other possibilities also exist.

Ride-services management system 501 may be configured to perform various other functions related to managing and facilitating ride services as well.

Referring again to FIG. 5, client station 502 of ride requestor 503 may generally comprise any computing device that is configured to facilitate interaction between ride requestor 503 and ride-services management system 501. For instance, client station 502 may take the form of a smartphone, a tablet, a desktop computer, a laptop, a netbook, and/or a PDA, among other possibilities. Each such device may comprise an I/O interface, a communication interface, a GNSS unit such as a GPS unit, at least one processor, data storage, and executable program instructions for facilitating interaction between ride requestor 503 and ride-services management system 501 (which may be embodied in the form of a software application, such as a mobile application, web application, or the like). In this respect, the interaction that may take place between ride requestor 503 and ride-services management system 501 may take various forms, representative examples of which may include requests by ride requestor 503 for new rides, confirmations by ride-services management system 501 that ride requestor 503 has been matched with an AV (e.g., AV 504), and updates by ride-services management system 501 regarding the progress of the ride, among other possibilities.

In turn, AV 504 may generally comprise any vehicle that is equipped with autonomous technology, and in accordance with the present disclosure, AV 504 may take the form of AV 300′ described above. Further, the functionality carried out by AV 504 as part of ride-services platform 500 may take various forms, representative examples of which may include receiving a request from ride-services management system 501 to handle a new ride, autonomously driving to a specified pickup location for a ride, autonomously driving from a specified pickup location to a specified drop-off location for a ride, and providing updates regarding the progress of a ride to ride-services management system 501, among other possibilities.

Generally speaking, third-party system 505 may include one or more computing systems that collectively comprise a communication interface, at least one processor, data storage, and executable program instructions for carrying out functions related to a third-party subservice that facilitates the platform's ride services. These one or more computing systems may take various forms and may be arranged in various manners, such as any one of the forms and/or arrangements discussed above with reference to ride-services management system 501.

Moreover, third-party system 505 may be configured to perform functions related to various subservices. For instance, as one possibility, third-party system 505 may be configured to monitor traffic conditions and provide traffic data to ride-services management system 501 and/or AV 504, which may be used for a variety of purposes. For example, ride-services management system 501 may use such data to facilitate fulfilling ride requests in the first instance and/or updating the progress of initiated rides, and AV 504 may use such data to facilitate updating certain predictions regarding perceived agents and/or the AV's behavior plan, among other possibilities.

As another possibility, third-party system 505 may be configured to monitor weather conditions and provide weather data to ride-services management system 501 and/or AV 504, which may be used for a variety of purposes. For example, ride-services management system 501 may use such data to facilitate fulfilling ride requests in the first instance and/or updating the progress of initiated rides, and AV 504 may use such data to facilitate updating certain predictions regarding perceived agents and/or the AV's behavior plan, among other possibilities.

As yet another possibility, third-party system 505 may be configured to authorize and process electronic payments for ride requests. For example, after ride requestor 503 submits a request for a new ride via client station 502, third-party system 505 may be configured to confirm that an electronic payment method for ride requestor 503 is valid and authorized and then inform ride-services management system 501 of this confirmation, which may cause ride-services management system 501 to dispatch AV 504 to pick up ride requestor 503. After receiving a notification that the ride is complete, third-party system 505 may then charge the authorized electronic payment method for ride requestor 503 according to the fare for the ride. Other possibilities also exist.

Third-party system 505 may be configured to perform various other functions related to subservices that facilitate the platform's ride services as well. It should be understood that, although certain functions were discussed as being performed by third-party system 505, some or all of these functions may instead be performed by ride-services management system 501.

As discussed above, ride-services management system 501 may be communicatively coupled to client station 502, AV 504, and third-party system 505 via communication network 506, which may take various forms. For instance, at a high level, communication network 506 may include one or more Wide-Area Networks (WANs) (e.g., the Internet or a cellular network), Local-Area Networks (LANs), and/or Personal Area Networks (PANs), among other possibilities, where each such network which may be wired and/or wireless and may carry data according to any of various different communication protocols. Further, it should be understood that the respective communications paths between the various entities of FIG. 5 may take other forms as well, including the possibility that such communication paths include communication links and/or intermediate devices that are not shown.

In the foregoing arrangement, client station 502, AV 504, and/or third-party system 505 may also be capable of indirectly communicating with one another via ride-services management system 501. Additionally, although not shown, it is possible that client station 502, AV 504, and/or third-party system 505 may be configured to communicate directly with one another as well (e.g., via a short-range wireless communication path or the like). Further, AV 504 may also include a user-interface system that may facilitate direct interaction between ride requestor 503 and AV 504 once ride requestor 503 enters AV 504 and the ride begins.

It should be understood that ride-services platform 500 may include various other entities and various other forms as well.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and sprit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

What is claimed is:

1. A computer-implemented method comprising:
obtaining data that characterizes a current scenario being faced by a vehicle that is operating in an autonomous mode while in a real-world environment;
based on the obtained data, determining that the current scenario being faced by the vehicle warrants presentation of scenario-based information to a user; and
in response to the determining, presenting a given set of scenario-based information to the user via one or both of a heads-up-display (HUD) system or a speaker system of the vehicle.

2. The computer-implemented method of claim 1, wherein:
the obtained data comprises an indicator of a given scenario type that is currently being faced by the vehicle; and
the determining comprises determining that the given scenario type matches one of a plurality of predefined scenario types that have been categorized as presenting increased risk.

3. The computer-implemented method of claim 1, wherein:
the obtained data comprises a value that reflects a likelihood of the vehicle making physical contact with another object in the real-world environment during a future window of time; and
the determining comprises determining that the obtained value satisfies a threshold condition associated with the likelihood of the vehicle making physical contact with another object.

4. The computer-implemented method of claim 1, wherein:
the obtained data comprises a value that reflects an urgency level of the current scenario being faced by the vehicle; and
the determining comprises determining that the obtained value satisfies a threshold condition associated with the urgency level.

5. The computer-implemented method of claim 1, wherein:
the obtained data comprises a value that reflects a likelihood that a safety driver of the vehicle will decide to switch the vehicle from the autonomous mode to a manual mode during a future window of time; and
the determining comprises determining that the obtained value satisfies a threshold condition associated with the likelihood that the safety driver of the vehicle will decide to switch the vehicle from the autonomous mode to the manual mode.

6. The computer-implemented method of claim 1, wherein the given set of scenario-based information is selected based on the obtained data that characterizes the current scenario being faced by the vehicle.

7. The computer-implemented method of claim 1, wherein the presenting comprises presenting a visual indication of a bounding box and a predicted future trajectory for at least one other object via the HUD system of the vehicle.

8. The computer-implemented method of claim 1, wherein the presenting comprises presenting a visual indication of a stop fence for the vehicle via the HUD system of the vehicle.

9. The computer-implemented method of claim 1, further comprising:
prior to determining that the current scenario being faced by the vehicle warrants presentation of scenario-based information, presenting baseline information via one or both of the HUD system or the speaker system of the vehicle while the vehicle is operating in the autonomous mode, wherein the baseline information is presented regardless of the current scenario being faced by the vehicle.

10. The computer-implemented method of claim 9, wherein the baseline information comprises a planned trajectory of the vehicle.

11. A non-transitory computer-readable medium comprising program instructions stored thereon that are executable by at least one processor such that a computing system is capable of:
obtaining data that characterizes a current scenario being faced by a vehicle that is operating in an autonomous mode while in a real-world environment;
based on the obtained data, determining that the current scenario being faced by the vehicle warrants presentation of scenario-based information to a user; and
in response to the determining, presenting a given set of scenario-based information to the user via one or both of a heads-up-display (HUD) system or a speaker system of the vehicle.

12. The computer-readable medium of claim 11, wherein:
the obtained data comprises an indicator of a given scenario type that is currently being faced by the vehicle; and
the determining comprises determining that the given scenario type matches one of a plurality of predefined scenario types that have been categorized as presenting increased risk.

13. The computer-readable medium of claim 11, wherein:
the obtained data comprises a value that reflects a likelihood of the vehicle making physical contact with another object in the real-world environment during a future window of time; and
the determining comprises determining that the obtained value satisfies a threshold condition associated with the likelihood of the vehicle making physical contact with another object.

14. The computer-readable medium of claim 11, wherein:
the obtained data comprises a value that reflects an urgency level of the current scenario being faced by the vehicle; and
the determining comprises determining that the obtained value satisfies a threshold condition associated with the urgency level.

15. The computer-readable medium of claim 11, wherein:
the obtained data comprises a value that reflects a likelihood that a safety driver of the vehicle will decide to switch the vehicle from the autonomous mode to a manual mode during a future window of time; and
the determining comprises determining that the obtained value satisfies a threshold condition associated with the likelihood that the safety driver of the vehicle will decide to switch the vehicle from the autonomous mode to the manual mode.

16. The computer-readable medium of claim 11, wherein the presenting comprises presenting a visual indication of a bounding box and a predicted future trajectory for at least one other object via the HUD system of the vehicle.

17. The computer-readable medium of claim 11, wherein the presenting comprises presenting a visual indication of a stop fence for the vehicle via the HUD system of the vehicle.

18. The computer-readable medium of claim 11, wherein the computer-readable medium further comprises program instructions stored thereon that are executable by the at least one processor such that the computing system is capable of:
prior to determining that the current scenario being faced by the vehicle warrants presentation of scenario-based information, presenting baseline information via one or both of the HUD system or the speaker system of the vehicle while the vehicle is operating in the autonomous mode, wherein the baseline information is presented regardless of the current scenario being faced by the vehicle.

19. An on-board computing system of a vehicle, the on-board computing system comprising:
at least one processor;
a non-transitory computer-readable medium; and
program instructions stored on the non-transitory computer-readable medium that are executable by the at least one processor such that the on-board computing system is capable of:
obtaining data that characterizes a current scenario being faced by the vehicle while operating in an autonomous mode while in a real-world environment;
based on the obtained data, determining that the current scenario being faced by the vehicle warrants presentation of scenario-based information to a user; and
in response to the determining, presenting a given set of scenario-based information to the user via one or both of a heads-up-display (HUD) system or a speaker system of the vehicle.

20. The on-board computing system of claim 19, wherein the obtained data comprises one or more of (i) an indicator of at least one given scenario type that is currently being faced by the vehicle, (ii) a value that reflects a likelihood of the vehicle making physical contact with another object in the real-world environment during a future window of time, (iii) a value that reflects an urgency level of the current scenario being faced by the vehicle, or (iv) a value that reflects a likelihood that a safety driver of the vehicle will decide to switch the vehicle from the autonomous mode to a manual mode during the future window of time.
